(19) United States
(12) Patent Application Publication
(10) Pub. No.: US 2025/0036473 A1
(43) Pub. Date: Jan. 30, 2025

(54) METHODS AND APPARATUS TO MANAGE CONFIGURATIONS OF CLOUD RESOURCES

(71) Applicant: VMware LLC, Palo Alto, CA (US)

(72) Inventors: SAIFUDDIN FAZLEHUSEN RANGWALA, Pune (IN); SURESH BALLA, Visakhapatnam (IN); AMIT MEENA, Pune (IN); NILESH KISANRAO DENGLE, Pune (IN); NEERAJ PRAMOD SHAH, Pune (IN)

(21) Appl. No.: 18/378,163

(22) Filed: Oct. 10, 2023

(30) Foreign Application Priority Data
Jul. 25, 2023 (IN) 202341049987

(51) Int. Cl. G06F 9/50

(52) U.S. Cl. CPC G06F 9/5033

(57) ABSTRACT

Systems, apparatus, articles of manufacture, and methods are disclosed to manage configuration of a cloud resource. An example system disclosed herein to manage configuration of a cloud resource includes programmable circuitry to at least one of execute or instantiate machine-readable instructions to compare a cloud resource configuration state with a cloud resource target configuration, generate an updated cloud resource configuration specification based on a difference between the cloud resource configuration state and the cloud resource target configuration, and cause an update of a cloud resource configuration parameter in a cloud provider based on the updated cloud resource configuration specification.

### RELATED APPLICATIONS

Benefit is claimed under 35 U.S.C. 119 (a)-(d) to Foreign application Ser. No. 202341049987 filed in India entitled “METHODS AND APPARATUS TO MANAGE CONFIGURATIONS OF CLOUD RESOURCES”, on Jul. 25, 2023, by VMware, Inc., which is herein incorporated in its entirety by reference for all purposes.

### FIELD OF THE DISCLOSURE

This disclosure relates generally to cloud computing and, more particularly, to methods and apparatus to manage configurations of cloud resources.

### BACKGROUND

A cloud resource configuration defines the structure of a deployment, including the types and properties of the resources that are part of the deployment. Cloud resource configuration management is a process for maintaining cloud resources in a desired state.

### BRIEF DESCRIPTION OF THE DRAWINGS

FIG. 1A is a schematic block diagram of an example environment in which an example cloud resource configuration management system operates to manage a cloud resource configuration of a cloud computing system.

FIG. 1B is a schematic block diagram of another example environment in which an example cloud implementation of a cloud resource configuration manager operates to manage a cloud resource configuration of a cloud computing system.

FIG. 1C is a schematic block diagram of another example environment in which an example on-premises implementation of cloud resource configuration manager and an automation platform plugin operate to manage a cloud resource configuration of a cloud computing system.

FIG. 2A is a block diagram of a cloud implementation of the example cloud resource configuration manager and the example cloud automation platform of FIG. 1B in a multi-cloud environment.

FIG. 2B is a block diagram of an on-premises implementation of the example cloud resource configuration manager and the example cloud automation platform plugin of FIG. 1C in a multi-cloud environment.

FIG. 3A is another block diagram of a cloud implementation of the example cloud resource configuration manager and the example cloud automation platform of FIGS. 1B and 2A to manage cloud resource configurations.

FIG. 3B is another block diagram of an on-premises implementation of the example cloud resource configuration manager and the example cloud automation platform plugin of FIGS. 1C and 2B to manage cloud resource configurations.

FIG. 4 is an example virtual private cloud (VPC) input specification.

FIG. 5 is an example VPC resource output specification.

FIG. 6 is an example cloud resource configuration status user interface of a cloud provider console output showing a cloud resource configuration status.

FIG. 7 is an interaction diagram of an example workflow to enforce a cloud resource desired state based on polling with an on-premises container orchestration platform of FIG. 2.

FIG. 8 is an interaction diagram of an example workflow to enforce a cloud resource desired state based on a trigger event with a cloud container orchestration platform of FIG. 2.

FIG. 9 is an example container orchestration platform operator log.

FIG. 10 is an example VPC output specification after a configuration drift.

FIG. 11 is a flowchart representative of example machine readable instructions and/or example operations that may be executed, instantiated, and/or performed by example programmable circuitry to implement the cloud resource configuration management system of FIG. 1A.

FIG. 12 is a flowchart representative of example machine readable instructions and/or example operations that may be executed, instantiated, and/or performed by example programmable circuitry to implement the cloud resource configuration manager and the cloud automation platform of FIGS. 1B, 2A and 3A with a cloud container orchestration platform.

FIG. 13 is a flowchart representative of example machine readable instructions and/or example operations that may be executed, instantiated, and/or performed by example programmable circuitry to implement the cloud resource configuration manager and the cloud automation platform plugin of FIGS. 1C, 2B and 3B with an on-premises container orchestration platform.

FIG. 14 is a block diagram of an example processing platform including programmable circuitry structured to execute, instantiate, and/or perform the example machine readable instructions and/or perform the example operations of FIGS. 11-13 to implement the core enforcement framework, the configuration service, the cloud resource configuration manager, the cloud automation platform, and/or the cloud automation platform plugin of corresponding ones of FIGS. 1A, 1B, 1C, 2A, 2B, 3A, and/or 3B.

FIG. 15 is a block diagram of an example implementation of the programmable circuitry of FIG. 14.

FIG. 16 is a block diagram of another example implementation of the programmable circuitry of FIG. 14.

FIG. 17 is a block diagram of an example software/firmware/instructions distribution platform (e.g., one or more servers) to distribute software, instructions, and/or firmware (e.g., corresponding to the example machine readable instructions of FIGS. 11-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to being within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Examples disclosed herein may be used to implement cloud resource configuration management. Cloud providers have their own desired state tools for managing their cloud resources. An individual cloud provider's desired state tools uses that cloud provider's own custom languages to manage its cloud resources. In multi-cloud deployments, where more than one cloud provider is used at a time, different languages are required to manage cloud resources from different cloud providers. For example, a cloud provider such as Amazon Web Services (AWS) uses an AWS CloudFormation service to manage infrastructure resources based on the JavaScript programming language (e.g., using JavaScript Object Notation (JSON)) or a Yet Another Markup Language (YAML)-formatted Infrastructure as a Code (IaC) template. In another example, a cloud provider such as Google Cloud uses Google Cloud Deployment Manager to manage infrastructure resources based on the Python programming language. In other examples, a cloud provider such as Azure uses Azure Resource Manager (ARM) to manage infrastructure resources based on Bicep, a domain-specific language (DSL). Although there are IaC tools to deploy resources in multi-cloud environments, such as Terraform, Pulumi, Ansible, etc. These IaC tools do not rectify cloud resource configuration drift. Configuration drift occurs when an infrastructure configuration (e.g., a cloud resource configuration) is inconsistent with its expected state. Configuration drift occurs when changes to software and hardware are made ad hoc and are not recorded or tracked in a comprehensive and systematic manner. Drift can be caused by human input, poor configuration, applications making unwanted changes, etc.

Examples disclosed herein pertain to managing configurations of cloud resources. Managing cloud resource configurations can be complicated, more so in multi-cloud environments. Cloud resource management is challenging due to the scales of cloud infrastructures and due to unpredictable interactions by large population of users with a system. A scale of a cloud infrastructure makes it less likely to have accurate overall state information of cloud resource configurations, and the large user base makes it nearly impossible to predict the type and the intensity of a system workload. Keeping track of parameters, secrets, and configuration items across environments is a significant undertaking. As a result, cloud resource configuration becomes more complicated in the cloud in which some items are managed by a cloud service provider and others managed by users. Combine that with the continuous deployment architecture of a cloud, and it quickly becomes difficult to track configuration items.

In a cloud, multiple tools provide automation for infrastructure, compliance and security management. Although prior configuration management tools are available for provisioning, version control of configurations, and recovery from critical events, such prior configuration management tools are custom-built (e.g., custom application programming interfaces (APIs), custom programming languages, etc.) by cloud vendors using IaC to specifically suit the needs of their offerings of cloud resources and cloud-based deployments. In addition, such prior custom-built configuration management tools require manual administrator management to monitor and update resource configurations in cloud deployments. However, each tool has its own role-based access control (RBAC) implementation which leads to using different custom semantics to access different cloud providers. Some fetch credentials from an environment, some form vaults, etc. To use such different RBAC implementations, different wrappers need to be created for different cloud providers. This creates significant difficulties and time-consuming resource management for multi-cloud deployments in which a cloud-based solution is deployed across multiple different cloud providers. In such multi-cloud deployments, a customer leases cloud resources to be provisioned across different cloud providers to satisfy geographic and/or capacity needs of its cloud-based solution. As such, an administration team must manually manage cloud resource configurations at the different cloud providers using different provider-specific tools.

Unlike prior solutions for managing cloud resource configurations of cloud resources provisioned across different cloud providers, examples disclosed herein may be used to implement a centralized cloud resource configuration manager based on a containerized application manager such as the Kubernetes platform, which is an open-source system for automating deployment, scaling, and managing of containerized applications. A disclosed example cloud resource configuration manager provides a developer-friendly interface that enables a customer to interact with cloud resources of different cloud providers according to their specific custom interface requirements while providing a same universal interface to the customer when managing the multiple cloud provider resources. In this manner, examples disclosed herein may be used to securely manage desired or target configuration states of multi-cloud resources which addresses self-healing, interpolation, CCRD (Cloud Custom Reference Definitions), user-friendly resource specifications, etc. As such, examples disclosed herein may be used to create guardrails to substantially increase the likelihood that cloud resources of multi-cloud deployments remain in compliance with desired or target configuration states.

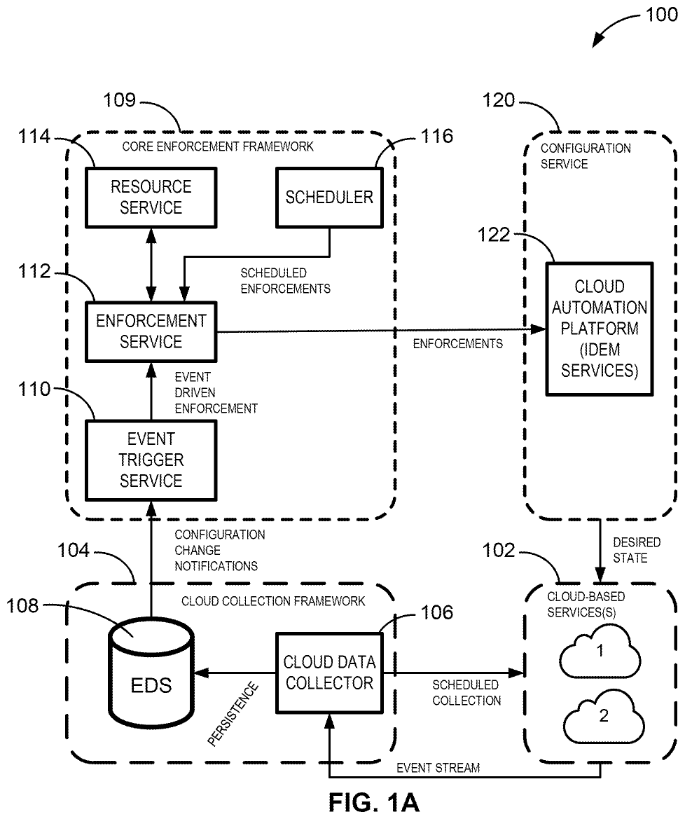

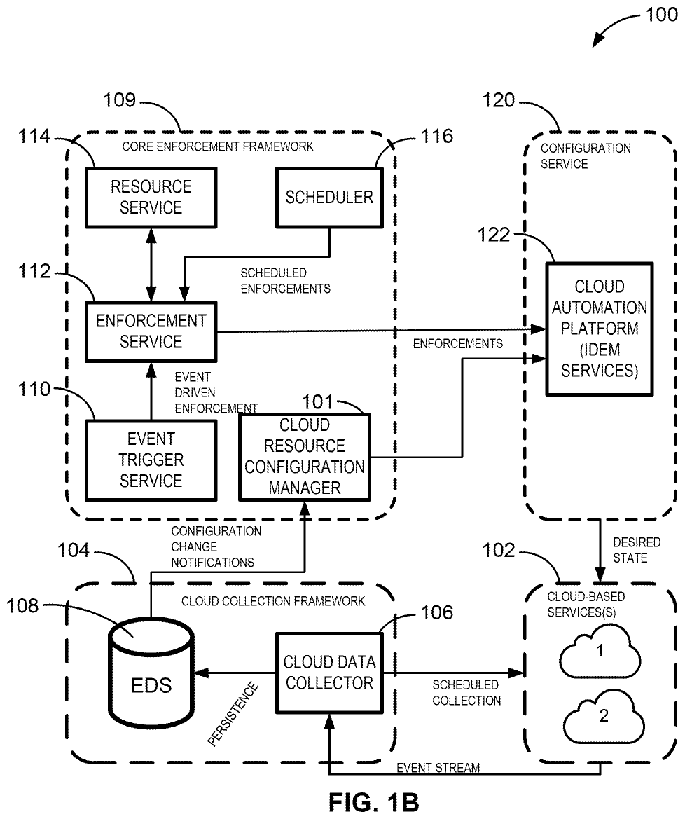

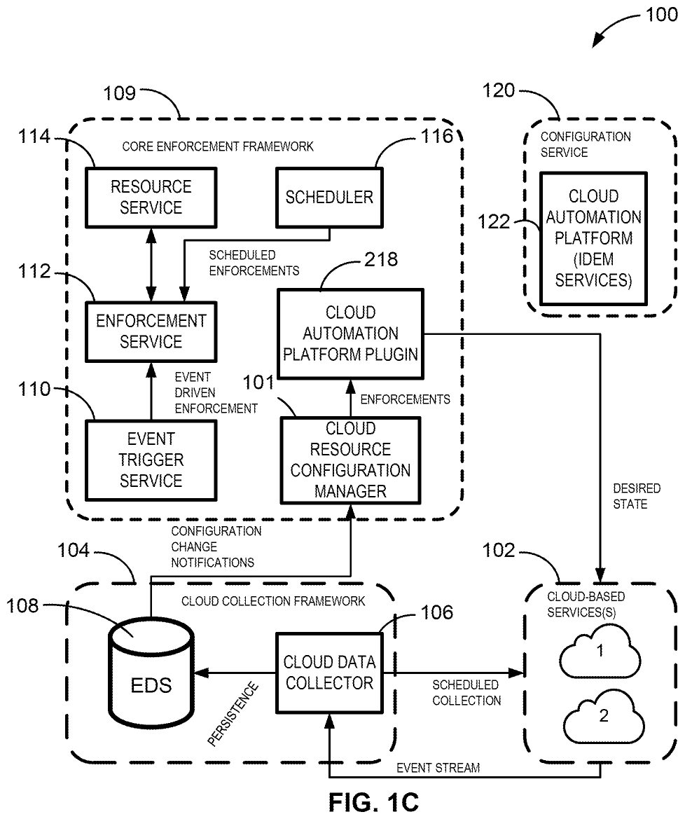

FIG. 1A is a schematic block diagram of an example environment 100 in which a cloud collection framework 104, a core enforcement framework 109, and a configuration service 109 operate to manage cloud resource configurations of cloud computing systems. In the illustrated example of FIG. 1A, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1A is only an example and any appropriate other architecture, network, control scheme, communication and/or data topology can be implemented instead.

According to examples disclosed herein, the example cloud collection framework 104 includes an example cloud data collector 106 to coordinate and communicate with the cloud-based service(s) 102. To that end, the example cloud data collector 106 can extract, receive and/or query information (e.g., components, metadata, services, service information) from the cloud-based service(s) 102. In this example, the cloud data collector 106 can request and/or direct the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide a requested or proposed configuration change request to the core enforcement framework 109 which, in turn, includes an example event trigger service 110, an example enforcement service 112, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to the configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service, also referred to as a cloud automation platform 122, that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based service(s) 102. In other words, the IDEM service 122 controls a desired state of the cloud-based service(s) 102 based on enforcements provided from the enforcement service 112.

FIG. 1B is a schematic block diagram of another example environment 100 in which a cloud implementation of the cloud resource configuration manager 101 operates to manage cloud resource configurations of cloud computing systems. In the illustrated example of FIG. 1B, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1B is only an example and any appropriate other architecture, network, control scheme, communication and/or data topology can be implemented instead.

In this example, the core enforcement framework 109 includes the example cloud resource configuration manager 101. The cloud resource configuration manager 101 of the illustrated example is implemented to maintain configuration of the cloud-based service(s) 102 by enforcing desired or target states of the cloud-based service(s) 102. For example, the cloud resource configuration manager 101 can map a configuration change event of a configuration parameter to a corresponding desired or target state of the cloud-based service(s) 102. Accordingly, the example cloud resource configuration manager 101 can maintain configurations of the cloud-based service(s) 102 in a desired or target state.

FIG. 1C is a schematic block diagram of another example environment 100 in which an example on-premises implementation of the cloud resource configuration manager 101 and the automation platform plugin 218 operate to manage cloud resource configurations of cloud computing systems. In the illustrated example of FIG. 1C, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1C is only an example and any appropriate other architecture, network, control scheme, communication and/or data topology can be implemented instead.

In this example, the core enforcement framework 109 includes the example cloud resource configuration manager 101 and the example cloud automation platform plugin 218. The cloud automation platform plugin 218 of the illustrated example is an implementation/provisioning engine that implements desired state changes with respect to the cloud-based service(s) 102. In other words, the example cloud automation platform plugin 218 controls desired or target states of the cloud-based service(s) 102 based on enforcements provided from the cloud resource configuration manager 101.

As mentioned above, any appropriate data topology, architecture and/or structure can be implemented instead. Further, any of the aforementioned aspects and/or elements described in connection with FIGS. 1A, 1B and 1C can be combined or separated as appropriate. Further, while examples disclosed herein are shown in the context of cloud services, examples disclosed herein can be implemented in conjunction with any appropriate distributed and/or shared computing resource system.

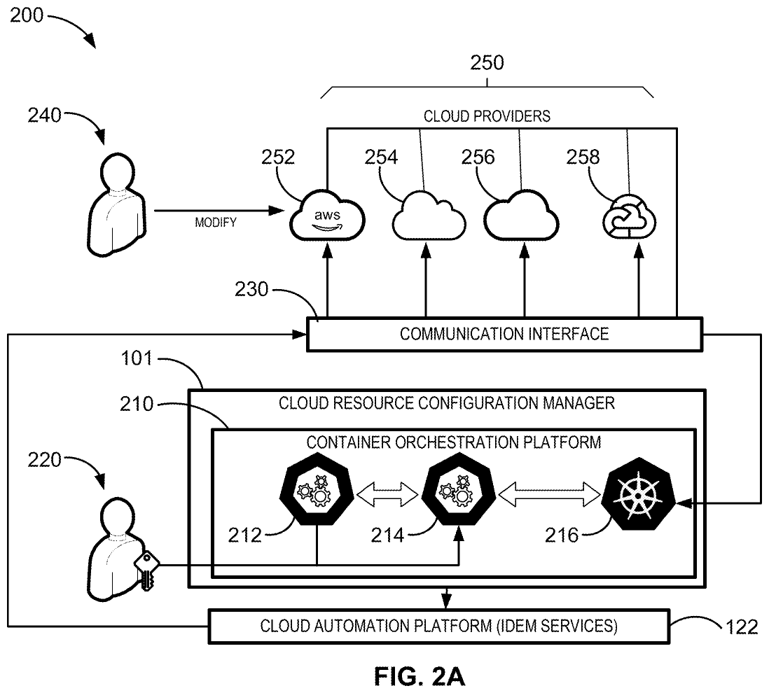

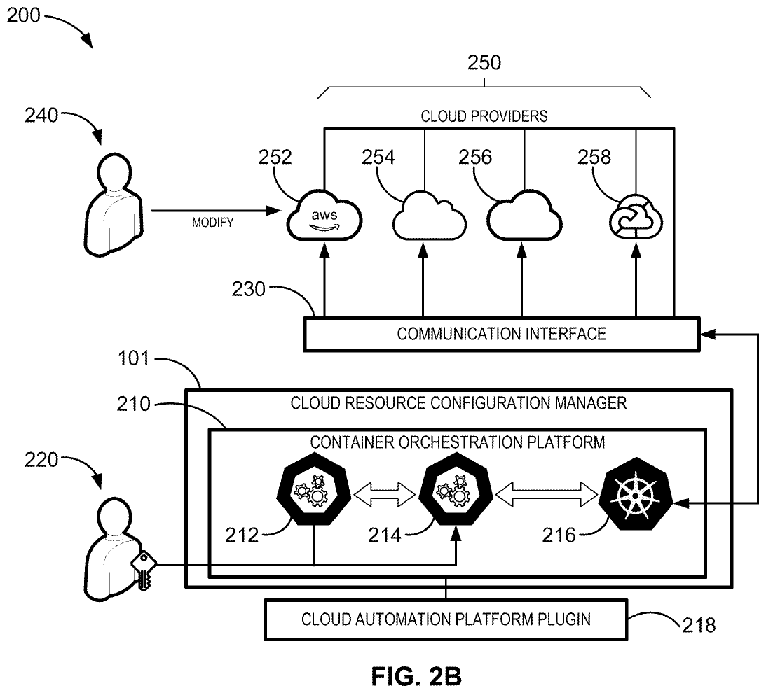

FIG. 2A is a block diagram of a cloud implementation of the cloud resource configuration manager 101 and the example cloud automation platform 122 of FIG. 1B in a multi-cloud resources environment 200. In the example multi-cloud resources environment 200, each cloud provider 250 has its own resource specification. As used herein, a resource specification is a text file that defines resources and properties that a cloud provider supports. An example authenticated operator 220 defines a cloud resource to be created or provisioned based on a resource specification of a cloud provider 250. The authenticated operator 220 defines the cloud resources based on the cloud type of a corresponding one of the cloud providers 250. A user 240 can modify a cloud resource configuration specification of any cloud resource corresponding to any of the cloud providers 250. If a modification is made, the example cloud resource configuration manager 101 maintains the cloud resources in a desired state. The example cloud resource configuration manager 101 sends target (e.g., desired) resource configuration parameters through the cloud automation platform (idem services) 122 to a cloud provider 250 through a communication interface 230. In some examples, the communication interface 230 can be implemented by an Amazon Web Services (AWS) software development kit (SDK) to communicate with an AWS cloud service 252, a Cloud9 SDK to communicate with a Cloud9 cloud service 254, an Azure SDK to communicate with an Azure cloud service 256, a Google cloud SDK to communicate with a Google cloud service 258, and/or any other SDK to communicate with any other cloud service. In examples disclosed herein, such different cloud-specific SDKs to communicate with cloud systems of different ones of the cloud providers 250 are examples of cloud-provider-specific communication interfaces in which communications to and from such different cloud providers 250 are generated according to cloud-provider-specific formats of the corresponding cloud providers 250. The example cloud resource configuration manager 101 includes a container orchestration platform 210.

The example container orchestration platform 210 may be implemented by a Kubernetes platform. In this example, the container orchestration platform 210 is deployed in a cloud environment. When deployed in a cloud environment, the container orchestration platform 210 is referred to as a cloud container orchestration platform. The container orchestration platform 210 includes a container orchestration platform server 212, a container orchestration platform operator service 214, and a container orchestration platform application programming interface (API) 216. When an operation is performed in a cloud resource configuration, a trigger event or alert is created by one or more of the cloud provider(s) 250. The example container orchestration platform server 212 receives the trigger event from the cloud provider(s) 250 and performs remediation of any changes to the cloud resource configuration. The example cloud resource configuration manager 101 communicates with the cloud provider(s) 250 through the example container orchestration platform API 216.

In the example disclosed herein, the cloud resources are custom resources modelled using a container orchestration platform custom resource definition (CRD). A custom resource definition (CRD) file defines object kinds and lets the container orchestration platform server 212 handle the entire lifecycle, from deployment to servicing a specified custom resource. The example authenticated operator 220 can define the CRD as container orchestration platform objects and, in response to the CRD, the container orchestration platform server 212 creates a new RESTful resource path that can be accessed by an entire cluster or a single project (e.g., a namespace). The example container orchestration platform API 216 is a resource-based (e.g., RESTful) programmatic interface provided via HTTP. The example container orchestration platform API 216 is the application that serves the container orchestration platform (e.g., Kubernetes) functionality though a RESTful interface and stores the state of the cluster. The example container orchestration platform 210 resources are stored as API objects and modified via RESTful calls to the container orchestration platform API 216. The example container orchestration platform API 216 allows a resource configuration to be managed in a declarative way. The example authenticated operator 220 can interact with the container orchestration platform API 216 directly or via tools like command line tools (e.g., the Kubernetes command line tool kubectl). In this manner, the authenticated operator 220 can manipulate the state of the API objects in the cloud resource configuration manager 101.

The example cloud automation platform 122 can be implemented by IDEM (e.g., the IDEM service 122 of FIG. 1). The example cloud automation platform 122 is provided to manage cloud resource configurations. For example, the cloud automation platform 122 manages the cloud resource configurations by defining and enforcing consistent results when executing application code on different clouds. The example authenticated operator 220 creates or generates a target resource configuration data file that describes a desired resource configuration and runs that target resource configuration data file periodically against a monitored resource configuration of a resource of interest to control configuration drift of that resource. If there are no changes in the monitored resource configuration since the last run (e.g., zero drift), the cloud automation platform 122 does not modify the monitored resource configuration. If the monitored resource configuration does not match the target resource configuration data file, the cloud automation platform 122 brings the monitored resource configuration back into compliance with the desired resource configuration specified in the target resource configuration data file. The example cloud automation platform 122 converts codebases for each cloud deployment and API into a format consisting of data that a user can understand and manage. Instead of IaC, the example cloud automation platform 122 uses infrastructure as data (IaD). The example cloud automation platform 122 can scan current cloud deployments and generate data needed to enforce it. The example cloud automation platform 122 takes the cloud description data and automates the enforcement of the cloud resource configurations. The example cloud automation platform 122 supports using a container orchestration platform custom resource definition (CRD) to enforce a desired state of a cloud resource. A CRD of the example container orchestration platform 210 is converted internally in the cloud automation platform 122 into a structured layer state (SLS) format used by the cloud automation platform (IDEM service) 122. In this manner, the cloud automation platform 122 reduces manual cloud configuration to fix configuration drifts. Instead, the cloud automation platform 122 automatically enforces the desired configuration state when a configuration drift occurs.

FIG. 2B is a block diagram of an example on-premises implementation of the cloud resource configuration manager 101 and the example cloud automation platform plugin 218 of FIG. 1C in a multi-cloud resources environment 200. Many of the structures of FIG. 2B are the same or similar to those present in FIG. 2A. In the interest of brevity, those structures will not be re-described here. Instead, the reader is referred to the above description of FIG. 2A for a full and complete description of those structures. To facilitate that process, like reference numbers are used for like structures in FIGS. 2A and 2B. In example FIG. 2B, the example cloud resource configuration manager 101 includes a container orchestration platform 210.

The example container orchestration platform 210 may be implemented by a Kubernetes platform. In some examples, the container orchestration platform 210 is deployed on-premises at a local data center (e.g., a local data center of a customer that is connected to one or more of the cloud providers 250 via the Internet). When deployed on-premises, the container orchestration platform 210 is referred to as an on-premises container orchestration platform.

The example cloud automation platform plugin 218 is provided to manage cloud resource configurations. For example, the cloud automation platform plugin 218 manages the cloud resource configurations by defining and enforcing consistent results when executing application code on different clouds. The example authenticated operator 220 creates or generates a target resource configuration data file that describes a desired resource configuration and runs that target resource configuration data file periodically against a monitored resource configuration of a resource of interest to control configuration drift of that resource. If there are no changes in the monitored resource configuration since the last run (e.g., zero drift), the cloud automation platform plugin 218 does not modify the monitored resource configuration. If the monitored resource configuration does not match the target resource configuration data file, the cloud automation platform plugin 218 brings the monitored resource configuration back into compliance with the desired or resource configuration specified in the target resource configuration data file. The example cloud automation platform plugin 218 converts codebases for each cloud deployment and API into a format consisting of data that a user can understand and manage. Instead of IaC, the example cloud automation platform plugin 218 uses infrastructure as data (IaD). The example cloud automation platform plugin 218 can scan current cloud deployments and generate data needed to enforce target resource configurations on the cloud deployments. The example cloud automation platform plugin 218 takes the cloud description data and automates the enforcement of the target resource configurations. The example cloud automation platform plugin 218 supports using a container orchestration platform custom resource definition (CRD) to enforce a desired state of a cloud resource. A CRD of the example container orchestration platform 210 is converted internally in the cloud automation platform plugin 218 into a structured layer state (SLS) format used by the cloud automation platform plugin 218. In this manner, the cloud automation platform plugin 218 reduces use of manual cloud configuration to fix configuration drifts. Instead, the cloud automation platform plugin 218 automatically enforces desired or target configuration states when configuration drifts occur.

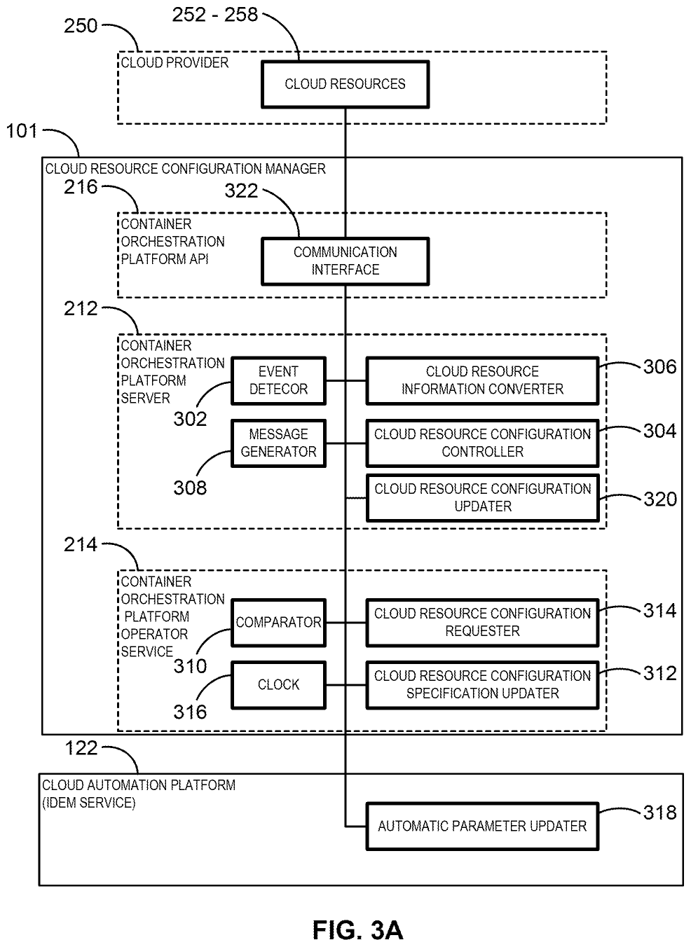

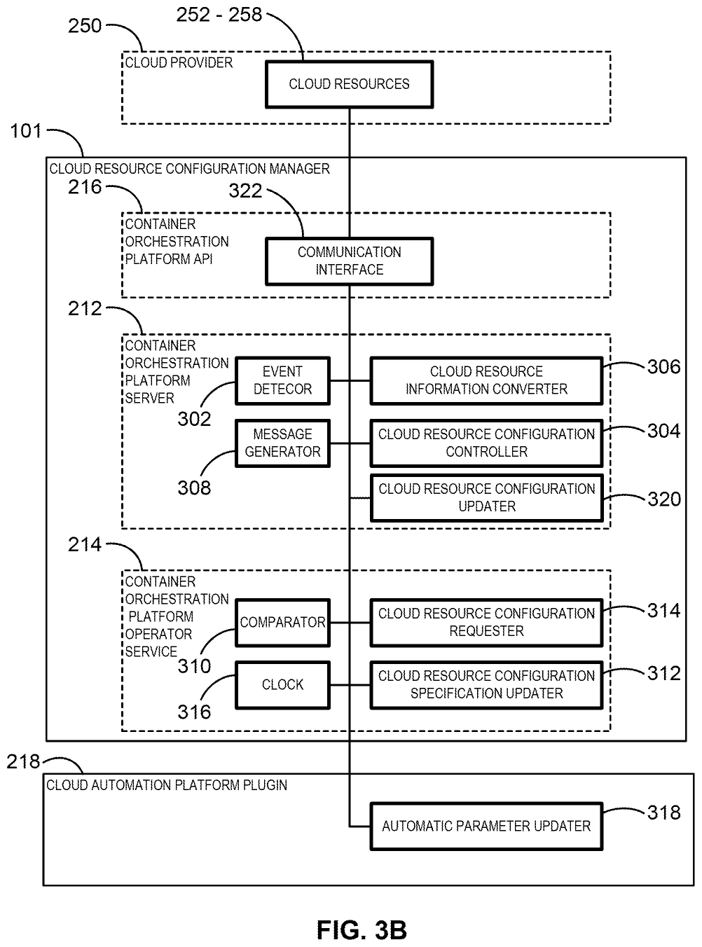

FIG. 3A is a block diagram of a cloud implementation of the cloud resource configuration manager 101 and the example cloud automation platform 122 of FIGS. 1B and 2A to manage cloud resource configurations by maintaining them in target or desired states (e.g., target configurations, desired configurations, etc.). The example cloud resource configuration manager 101 of FIG. 3A may be instantiated (e.g., creating an instance of, bring into being for any length of time, materialize, implement, etc.) by programmable circuitry such as a Central Processor Unit (CPU) executing first instructions. Additionally or alternatively, the cloud resource configuration manager 101 of FIG. 3A may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3A may, thus, be instantiated at the same or different times. Some or all of the circuitry of FIG. 3A may be instantiated, for example, in one or more threads executing concurrently on hardware and/or in series on hardware. Moreover, in some examples, some or all of the circuitry of FIG. 3A may be implemented by microprocessor circuitry executing instructions and/or FPGA circuitry performing operations to implement one or more virtual machines and/or containers.

As represented in example FIG. 3A, the container orchestration platform server 212 includes an event detector 302, a cloud resource configuration controller 304, a cloud resource information converter 306, a message generator 308, and a cloud resource configuration updater 320. Also in example FIG. 3A, the container orchestration platform operator service 214 includes a comparator 310, a cloud resource configuration specification updater 312, a cloud resource configuration requester 314, and a clock 316. Also in example FIG. 3A, the container orchestration platform API 216 includes a communication interface 322, and the cloud automation platform (IDEM service) 122 includes an automatic parameter updater 318.

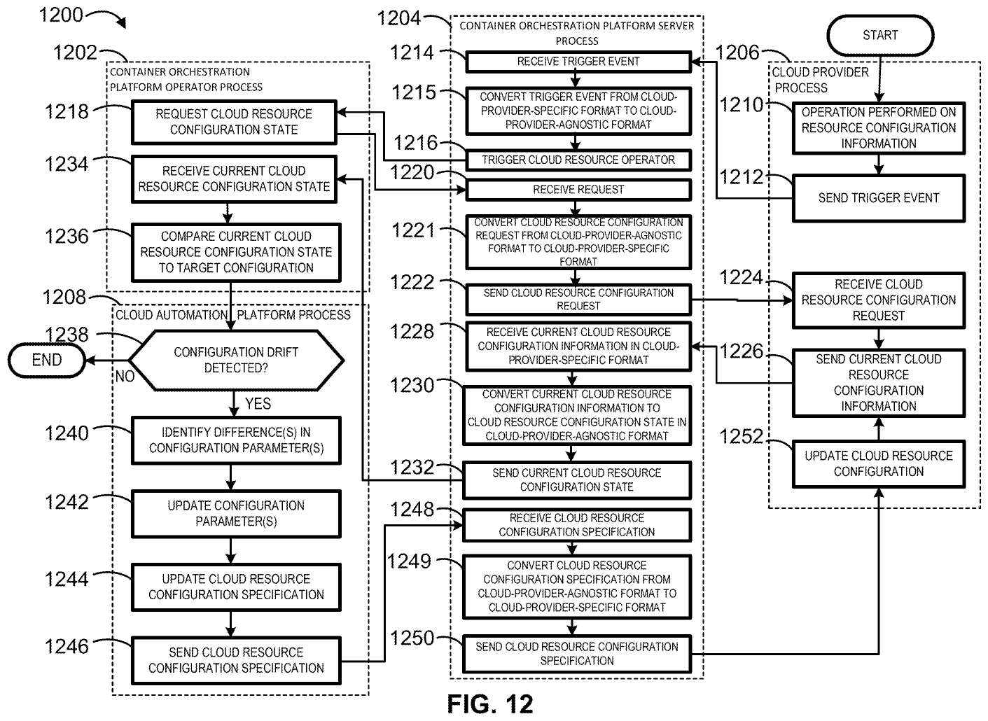

In some examples, the event detector circuitry 302 is instantiated by programmable circuitry executing event detector instructions and/or configured to perform operations such as those represented by the flowchart of FIG. 12. The example event detector circuitry 302 is to detect a cloud resource event (e.g., a trigger event or alert). For example, a trigger event is generated based on an operation performed on a cloud resource to change a configuration of that cloud resource. In some examples, the operation performed causes a configuration drift. Configuration drift is a change in cloud resource configuration information or state relative to original parameter settings in the resource configuration of the cloud resource used at deployment. To monitor for configuration drift, a current cloud resource configuration state is used to analyze current parameter settings of a cloud resource configuration. For example, current parameter settings of an existing input specification can be defined by the authenticated operator 220 (FIG. 2A). Configuration drifts can be caused by a user making out-of-band changes to resource configurations when troubleshooting or performing another ad hoc task. In some examples, a trigger event causes the cloud resource configuration manager 101 to 1) create a new cloud resource configuration parameter when there is a configuration drift, or 2) update a cloud resource configuration state when there is a configuration drift, or 3) ignore the trigger event if there is no difference between a current monitored cloud resource configuration state and a target cloud resource configuration.

The example cloud resource configuration controller 304 is provided to receive updated cloud resource configuration specifications from the container orchestration platform operator service 214 and update configuration states of cloud resources 252-258 (FIG. 2A). When configuration drift occurs in a cloud resource 252-258, the example container orchestration platform operator service 214 updates the details of the cloud resource desired state in the cloud resource configuration specification. The example cloud resource configuration controller 304 rectifies configuration drifts by applying updated cloud resource configuration specifications to configuration states of the cloud resources 252-258.

The example cloud resource information converter 306 is provided to convert cloud resource configuration information from the cloud provider(s) 250 to a cloud resource configuration state that can be read and interpreted by the cloud automation platform 218. For example, the cloud resource configuration information from the cloud provider(s) 250 includes cloud-provider-specific formatting for resource configuration information. Cloud-provider-specific formatting allows communicating with an individual could provider 250 based on its own custom tools, APIs, and/or programming language to manage resource configurations. For example, an AWS cloud provider allows deploying resources in an Elastic Compute Cloud (EC2), while an Azure cloud provider allows deploying resources in a virtual machine (VM). Tools, APIs, and/or programming languages to manage resource configurations will differ between the two types of resource deployments. For example, the AWS cloud provider uses an AWS CloudFormation tool and its own APIs and/or programming language to manage resources. The Azure cloud provider uses Azure Resource Manager (ARM) and its own APIs and/or programming language to manage resources. A Google cloud provider uses a Google Cloud Resource Manager and its own APIs and/or programming language to manage resources. The cloud resource configuration state is a conversion or translation of the cloud-provider-specific format to a cloud-provider-agnostic format. A cloud-provider-agnostic format can be implemented using, for example, SLS formatting to work with the cloud automation platform (IDEM service) 122 as an IaC, which eliminates the need for the cloud automation platform 122 and/or an end user to work with the complex implementations of individual cloud providers 250 and instead exposes a common framework to the cloud automation platform 122 and/or the end user. In this manner, the cloud automation platform 122 and/or the end user need only be familiar with one, same interface to manage resources associated with different ones of the cloud providers 250. By using such cloud-provider-agnostic formatting, an end user and/or the cloud automation platform 122 can interface through the container orchestration platform 210 with any one or more of the cloud provider(s) 250 to manage cloud resources across any of the cloud providers 250 without needing to know the cloud-provider-specific formatting of resource configuration information for each of the cloud providers 250. In example FIG. 2A, the cloud resource configuration state is sent to the container orchestration platform operator service 214 to check for configuration drift (e.g., a change in cloud resources configuration).

The example message generator 308 is provided to send polling messages from the cloud resource configuration manager 101 to the cloud provider(s) 250 at set or periodic intervals. The polling messages request the example cloud provider(s) 250 to send cloud resource configuration information to the cloud resource configuration manager 101. The cloud resource configuration information is used to determine if a configuration drift occurred.

The example cloud resource configuration updater 320 is provided to update a cloud resource configuration parameter in a cloud provider 250 based on an updated cloud resource configuration specification. The cloud resource configuration state is associated with active parameter settings. The cloud resource configuration active parameter settings can include at least one of a specification parameter, a status parameter, or an event parameter. The example cloud resource configuration updater 320 updates the cloud resource configuration parameter when there is a drift in the parameter from the desired state.

The example comparator 310 is provided to compare a cloud resource configuration state against a target or desired state configuration. If there is a configuration drift, the cloud resource configuration manager 101 updates the cloud resource configuration.

The example cloud resource configuration specification updater 312 is provided to update a cloud resource configuration specification when a configuration drift occurs. The example cloud resource configuration specification updater 312 updates the cloud resource configuration specification to the target or desired state configuration. The example cloud resource configuration specification updater 312 causes transmission of the updated cloud resource configuration specification to the container orchestration platform server 212. The example container orchestration platform server 212 transmits the updated cloud resource configuration specification to cloud provider(s) 250 to update cloud resources 252-258 (FIG. 2A).

The example cloud resource configuration requester 314 is provided to poll (e.g., send requests) for cloud resource configuration information from cloud provider(s) 250. The example cloud resource configuration requester 314 regularly polls for the cloud resource configuration information at periodic intervals. The cloud resource configuration information received allows the example cloud resource configuration manager 101 to determine if the cloud resource configuration drifted.

The example clock 316 is provided to set a polling interval for poll requests. In the example disclosed herein, the poll interval is configured as one minute, although any other interval can be used.

The example communication interface 322 is provided to send requests for cloud resource configuration information in a polling fashion and send updated cloud resource configuration specifications to cloud provider(s) 250. The requests for cloud resource configuration information trigger the cloud provider(s) 250 to send the cloud resource configuration information to the example cloud resource configuration manager 101. The updated cloud resource configuration specification is sent to the cloud provider(s) 250 to enable the cloud provider(s) 250 to rectify any cloud resource configuration drifts that may have occurred.

The example automatic parameter updater 318 is provided to identify differences between current resource configuration parameters and target configuration parameters and automatically update the current configuration parameters to match the target configuration parameters. A difference in a current configuration parameter is detected when there is a configuration drift. As described above, a configuration drift can be caused by user input when troubleshooting or performing other operations on cloud resources 252-258 (FIG. 2A).

FIG. 3B is a block diagram of an on-premises implementation of the example cloud resource configuration manager 101 and the example cloud automation platform plugin 218 of FIGS. 1C and 2B to manage cloud resource configurations by maintaining them in target or desired states (e.g., target configurations, desired configurations, etc.). Many of the structures of FIG. 3B are the same or similar to those present in FIG. 3A. In the interest of brevity, those structures will not be re-described here. Instead, the reader is referred to the above description of FIG. 3A for a full and complete description of those structures. To facilitate that process, like reference numbers are used for like structures in FIGS. 3A and 3B. In the example FIG. 3B, the example on-premises implementation of the cloud resource configuration manager 101 uses the cloud automation platform plugin 218 instead of the cloud automation platform (IDEM service) 122 (FIG. 2A).

As represented in example FIG. 3B, the cloud automation platform plugin 218 includes an automatic parameter updater 318. The example cloud automation platform plugin 218 performs the function of the cloud automation platform (IDEM service) 122 as described in FIG. 3A. The example cloud automation platform plugin 218 reads and interprets the cloud resource configuration state provided by the example cloud resource information converter 306 (FIG. 3B). The cloud automation platform plugin 218 receives the cloud resource configuration state in a cloud-provider-agnostic format. A cloud-provider-agnostic format can be implemented using, for example, SLS formatting to work with the example cloud automation platform plugin 218 as an IaC, which eliminates the need for the cloud automation platform plugin 218 and/or an end user to work with the complex implementations of individual cloud providers 250 and instead exposes a common framework to the cloud automation platform plugin 218 and/or the end user. In this manner, the example cloud automation platform plugin 218 and/or the end user need only be familiar with one, same interface to manage resources associated with different ones of the cloud providers 250. By using such cloud-provider-agnostic formatting, an end user and/or the cloud automation platform plugin 218 can interface through the container orchestration platform 210 with any one or more of the cloud provider(s) 250 to manage cloud resources across any of the cloud providers 250 without needing to know the cloud-provider-specific formatting of resource configuration information for each of the cloud providers 250.

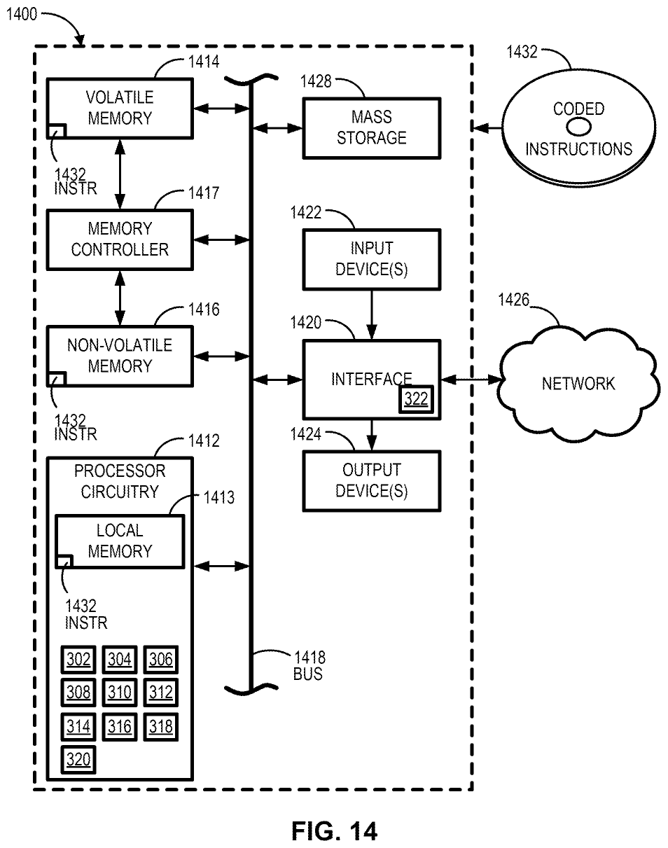

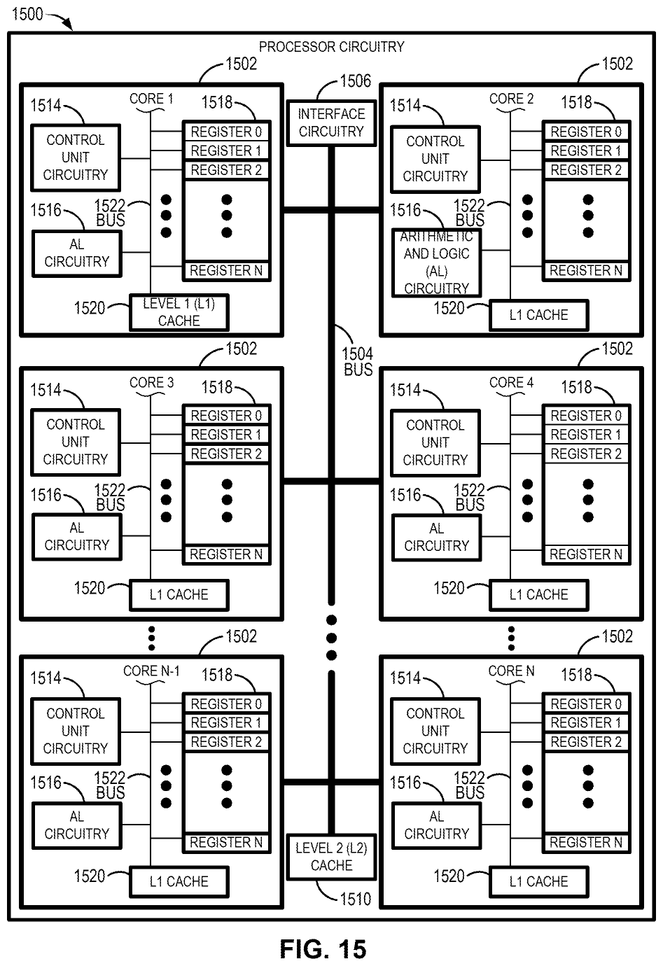

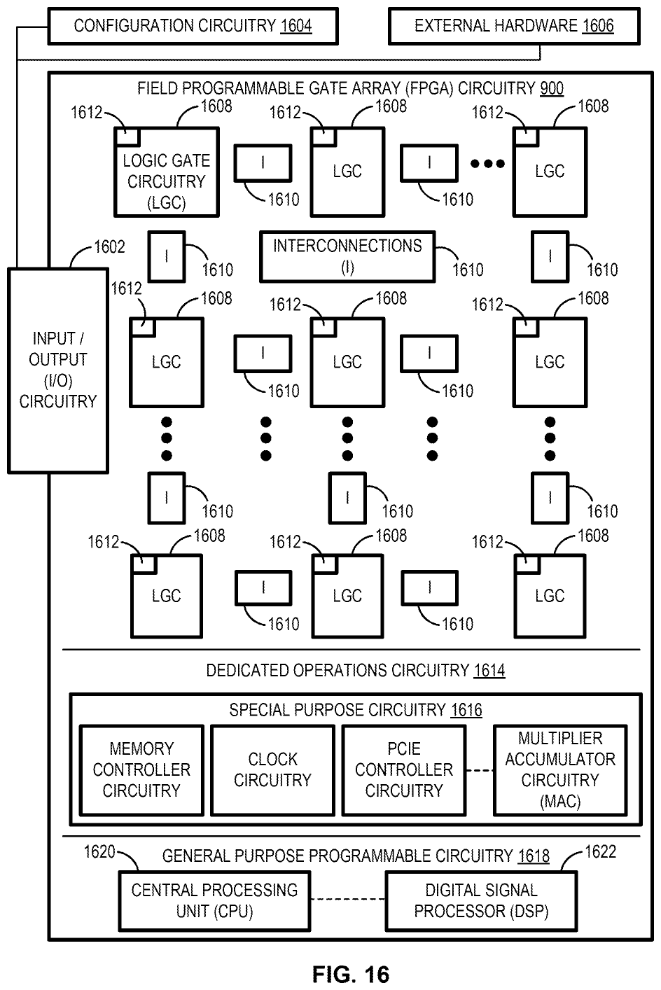

In some examples, the cloud resource configuration manager 101 includes means for detecting a trigger event from a cloud provider. For example, the means for detecting a trigger event may be implemented by event detector circuitry such as the event detector 302. In some examples, the event detector 302 may be instantiated by programmable circuitry such as the example programmable circuitry 1412 of FIG. 14. For instance, the event detector 302 may be instantiated by the example microprocessor 1500 of FIG. 15 executing machine executable instructions such as those implemented by at least blocks 1214 of FIG. 12. In some examples, the event detector 302 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the event detector 302 may be instantiated by any other combination of hardware, software, and/or firmware. For example, the event detector 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud resource configuration manager 101 includes means for causing transmission of an updated cloud resource configuration specification to cloud provider(s). For example, the means for causing transmission of an updated cloud resource configuration specification may be implemented by cloud resource configuration controller circuitry such as the cloud resource configuration controller 304. In some examples, the cloud resource configuration controller 304 may be instantiated by programmable circuitry such as the example programmable circuitry 1412 of FIG. 14. For instance, the cloud resource configuration controller 304 may be instantiated by the example microprocessor 1500 of FIG. 15 executing machine executable instructions such as those implemented by at least blocks 1248 and 1250 of FIGS. 12 and 1340, 1342, FIG. 13. In some examples, the cloud resource configuration controller 304 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the cloud resource configuration controller 304 may be instantiated by any other combination of hardware, software, and/or firmware. For example, the cloud resource configuration controller 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

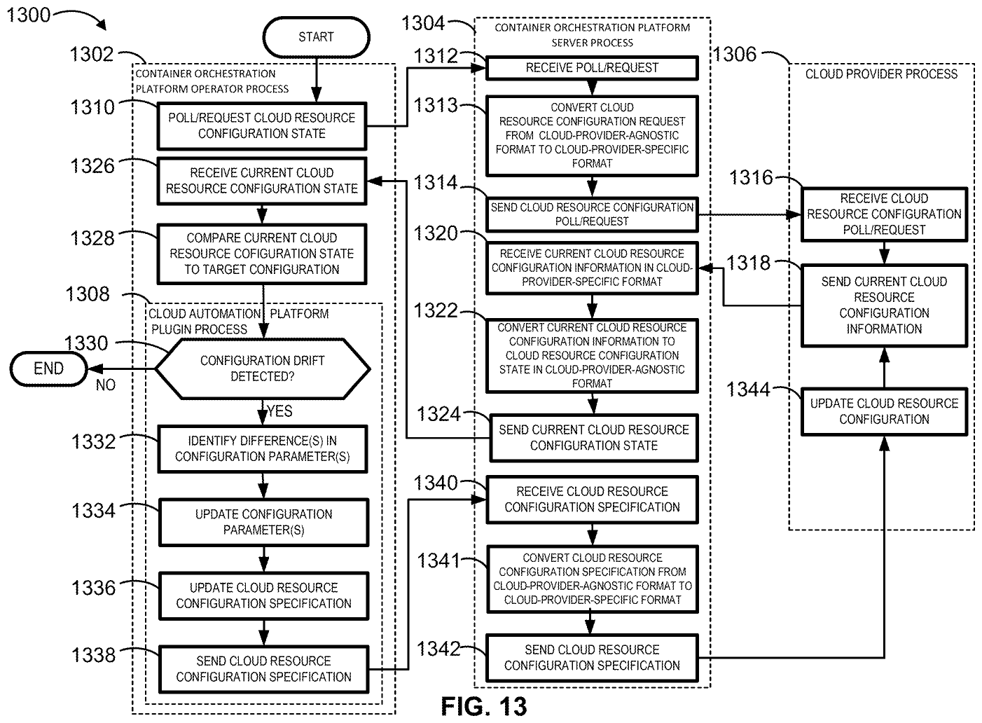

In some examples, the cloud resource configuration manager 101 includes means for converting cloud resource configuration information from a cloud provider to a cloud resource configuration state. For example, the means for converting may be implemented by cloud resource information converter circuitry such as the cloud resource information converter 306. In some examples, the cloud resource information converter 306 may be instantiated by programmable circuitry such as the example programmable circuitry 1412 of FIG. 14. For instance, the cloud resource information converter 306 may be instantiated by the example microprocessor 1500 of FIG. 15 executing machine executable instructions such as those implemented by at least blocks 1228, 1230 and 1232 of FIG. 12 and blocks 1320, 1322, 1324 of FIG. 13. In some examples, the cloud resource information converter 306 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the cloud resource information converter 306 may be instantiated by any other combination of hardware, software, and/or firmware. For example, the cloud resource information converter 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud resource configuration manager 101 includes means for comparing a cloud resource configuration state to a cloud resource target configuration. For example, the means for comparing may be implemented by comparator circuitry such as the comparator 310. In some examples, the comparator 310 may be instantiated by programmable circuitry such as the example programmable circuitry 1412 of FIG. 14. For instance, the comparator 310 may be instantiated by the example microprocessor 1500 of FIG. 15 executing machine executable instructions such as those implemented by at least blocks 1236, 1238 of FIGS. 12 and 1328, 1330 of FIG. 13. In some examples, the comparator 310 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the comparator 310 may be instantiated by any other combination of hardware, software, and/or firmware. For example, the comparator 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud resource configuration manager 101 includes means for generating an updated cloud resource configuration specification. For example, the means for generating an updated cloud resource configuration specification may be implemented by cloud resource configuration specification updater circuitry such as the cloud resource configuration specification updater 312. In some examples, the cloud resource configuration specification updater 312 may be instantiated by programmable circuitry such as the example programmable circuitry 1412 of FIG. 14. For instance, the cloud resource configuration specification updater 312 may be instantiated by the example microprocessor 1500 of FIG. 15 executing machine executable instructions such as those implemented by at least blocks 1244, 1246 of FIGS. 12 and 1336, 1338 of FIG. 13. In some examples, the cloud resource configuration specification updater 312 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the cloud resource configuration specification updater 312 may be instantiated by any other combination of hardware, software, and/or firmware. For example, the cloud resource configuration specification updater 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud resource configuration manager 101 includes means for polling and requesting a cloud resource configuration state. For example, the means for polling and requesting a cloud resource configuration state may be implemented by cloud resource configuration requester circuitry such as the cloud resource configuration requester 314. In some examples, the cloud resource configuration requester 314 may be instantiated by programmable circuitry such as the example programmable circuitry 1412 of FIG. 14. For instance, the cloud resource configuration requester 314 may be instantiated by the example microprocessor 1500 of FIG. 15 executing machine executable instructions such as those implemented by at least blocks 1218 of FIGS. 12 and 1310 of FIG. 13. In some examples, the cloud resource configuration requester 314 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the cloud resource configuration requester 314 may be instantiated by any other combination of hardware, software, and/or firmware. For example, the cloud resource configuration requester 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud resource configuration manager 101 includes means for tracking the intervals at which to perform polling. For example, the means for tracking the intervals may be implemented by clock circuitry such as the clock 316. In some examples, the clock 316 may be instantiated by programmable circuitry such as the example programmable circuitry 1412 of FIG. 14. For instance, the clock 316 may be instantiated by the example microprocessor 1500 of FIG. 15 executing machine executable instructions such as those implemented by at least block 1310 of FIG. 13. In some examples, the clock 316 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the clock 316 may be instantiated by any other combination of hardware, software, and/or firmware. For example, the clock 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud resource configuration manager 101 includes means for automatically selecting parameter settings to update in the cloud resource configuration specification. For example, the means for automatically selecting parameter settings may be implemented by automatic parameter updater circuitry such as the automatic parameter updater 318. In some examples, the automatic parameter updater 318 may be instantiated by programmable circuitry such as the example programmable circuitry 1412 of FIG. 14. For instance, the automatic parameter updater 318 may be instantiated by the example microprocessor 1500 of FIG. 15 executing machine executable instructions such as those implemented by at least blocks 1240, 1242 of FIGS. 12 and 1332, 1334 of FIG. 13. In some examples, the automatic parameter updater 318 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the automatic parameter updater 318 may be instantiated by any other combination of hardware, software, and/or firmware. For example, the automatic parameter updater 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the cloud resource configuration manager 101 includes means for causing an update of a cloud resource configuration parameter in a cloud provider. For example, the means for causing an update may be implemented by cloud resource configuration updater circuitry such as the cloud resource configuration updater 320. In some examples, the cloud resource configuration updater 320 may be instantiated by programmable circuitry such as the example programmable circuitry 1412 of FIG. 14. For instance, the cloud resource configuration updater 320 may be instantiated by the example microprocessor 1500 of FIG. 15 executing machine executable instructions such as those implemented by at least blocks 1248, 1250 of FIGS. 12 and 1340, 1342 of FIG. 13. In some examples, the cloud resource configuration updater 320 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the cloud resource configuration updater 320 may be instantiated by any other combination of hardware, software, and/or firmware. For example, the cloud resource configuration updater 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the cloud resource configuration manager 101 of FIGS. 1 and 2 is illustrated in FIG. 3, one or more of the elements, processes, and/or devices illustrated in FIG. 3 may be combined, divided, re-arranged, omitted, eliminated, and/or implemented in any other way. Further, the example event detector 302, the example cloud resource configuration controller 304, the example cloud resource information converter 306, the example message generator 308, the example comparator 310, the example cloud resource configuration specification updater 312, the example cloud resource configuration requester 314, the example clock 316, the example automatic parameter updater 318, the example cloud resource configuration updater 320, the example communication interface 322, and/or, more generally, the example cloud resource configuration manager 101 of FIG. 3, may be implemented by hardware alone or by hardware in combination with software and/or firmware. Thus, for example, any of the example event detector 302, the example cloud resource configuration controller 304, the example cloud resource information converter 306, the example message generator 308, the example comparator 310, the example cloud resource configuration specification updater 312, the example cloud resource configuration requester 314, the example clock 316, the example automatic parameter updater 318, the example cloud resource configuration updater 320, the example communication interface 322, and/or, more generally, the example cloud resource configuration manager 101, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example cloud resource configuration manager 101 of FIG. 3 may include one or more elements, processes, and/or devices in addition to, or instead of, those illustrated in FIG. 3, and/or may include more than one of any or all of the illustrated elements, processes and devices.

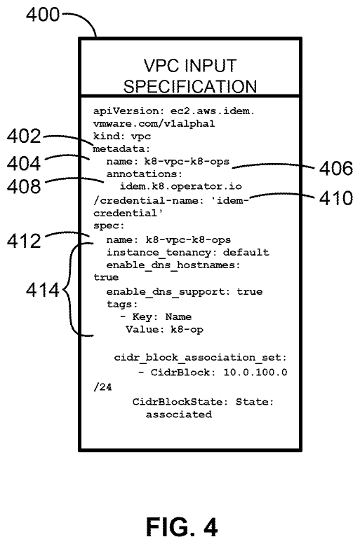

FIG. 4 is an example virtual private cloud (VPC) input specification 400. A VPC is a service that allows a user 240 (FIG. 2) to launch a cloud provider resources in a logically isolated virtual network defined by the user 240. In the illustrated example of FIG. 4, the VPC type specified by the VPC input specification 400 is an Amazon Web Services (AWS) VPC. In some examples, the user 240 creates the VPC input specification 400 using the container orchestration platform API 216 (FIGS. 2 and 3). The example VPC input specification 400 specifies a resource as a “VPC” in a “kind” field 402. The “kind” field 402 specifies the type of resource in the custom resource definition (CRD). The example VPC input specification 400 indicates a name of the VPC under a VPC input specification metadata section 404 in a name field 406 as k8-vpc-k8-ops. k8-vpc-k8-ops is the name for the CRD. An example annotations field 408 in the metadata section 404 includes details of a pointer that points to an account and region that should be used to create a cloud resource. In the illustrated example of FIG. 4, the pointer shows idem.k8.operator.io/credential-name: ‘idem-credential’ 410. Based on the information in the annotations field 408, the example container orchestration platform operator service 214 (FIGS. 2 and 3) calls the cloud automation platform 218 (FIGS. 2 and 3). In some examples, the cloud automation platform 218 can be implemented by a multi-cloud management automation platform such as the IDEM service 122 of FIG. 1. The example cloud automation platform 218 calls an AWS Software Development Kit (SDK) with input parameters from the cloud resource configuration manager 101.

An example specification (“spec”) field 412 in the VPC input specification 400 lists resource parameters required by a target or desired state based on a container orchestration platform standard of the container orchestration platform 210 (FIG. 2). In some examples, the container orchestration platform 210 may be implemented by Kubernetes, an open-source system for automating deployment, scaling, and management of containerized applications. The example specification field 412 is the input section for VPC input parameters 414. The example VPC input parameters 414 vary across different cloud resources. In the illustrated example, the VPC input parameters 414 refer to an AWS VPC cloud resource. In some examples, the cloud resources can be an elastic compute cloud (EC2) instance, a subnet, a route table, a CloudWatch (Application and Infrastructure Monitoring), a DynamoDB (NoSQL database), an Identity and Access Management (IAM), an AWS Organizations, an AWS Relational Database Service (RDS), an Amazon Route 53 (cloud domain name service), an Amazon S3 (cloud object storage), etc.

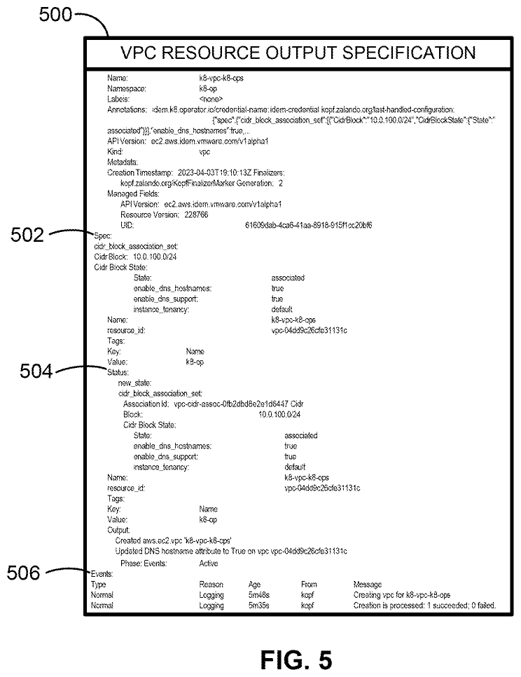

FIG. 5 is an example VPC resource output specification 500 for a cloud resource. VPC resource output specifications such as the example VPC resource output specification 500 may be used to identify VPC resources and related information after they are created by the container orchestration platform operator service 214 (FIGS. 2 and 3) by applying a VPC specification (e.g., the VPC input specification 400 of FIG. 4) to a container orchestration platform cluster. The example VPC resource output specification 500 includes three main sections along with other parameters. The three main sections include a specification section 502, a status section 504, and an events section 506. The example specification section 502 includes the same resource configurations as the VPC input parameters 414 (FIG. 4) used to set a desired state or target state in the VPC input specification 400. The example status section 504 includes the output generated from the cloud automation platform 218 (FIGS. 2 and 3) after VPC creation. The example status section 504 includes the current parameters in use in the cloud resource. In the illustrated example of FIG. 5, the status section 504 identifies current parameters in use in the cloud resource. In the example disclosed herein, the cloud resource is identified as an AWS cloud resource in the status section 504. The example event section 506 is a logging section of the VPC resource output specification 500. It identifies trigger events that are generated, and actions taken for those trigger events.

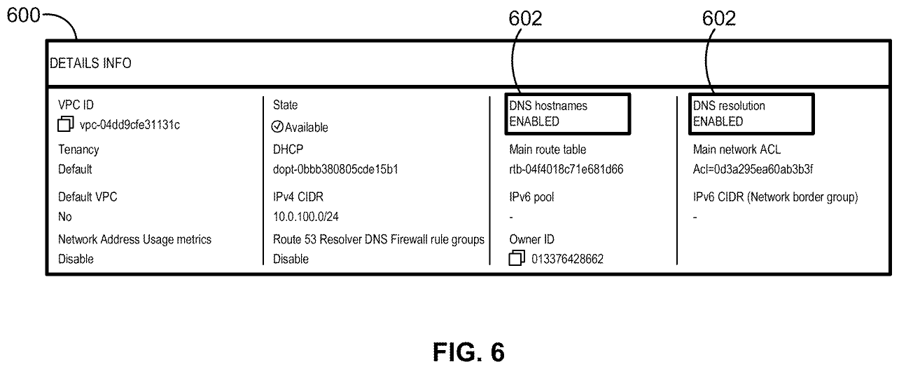

FIG. 6 is an example cloud resource configuration status user interface (UI) 600 of a cloud provider console output showing a cloud resource configuration status. In the illustrated example, the cloud resource configuration status UI 600 is from an AWS console after a VPC is created. Example parameters 602 define a configuration from a YAML specification which specifies a cloud resource configuration input specification. In some examples of a YAML specification, the domain name system (DNS) hostnames and DNS support parameters are set to true using the following configuration input “enable_dns_hostnames: true” and “enable_dns_support: true”.

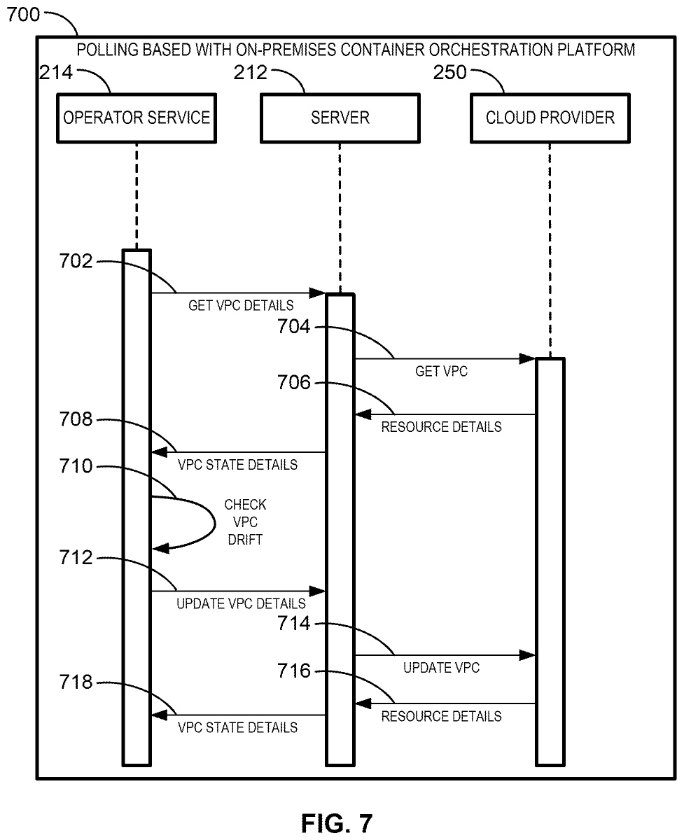

FIG. 7 is an interaction diagram of an example workflow 700 to enforce a cloud resource desired state (e.g., a cloud resource target state) based on polling with the on-premises container orchestration platform 210 (FIG. 2B). To enforce a desired state of cloud resources using the example on-premises container orchestration platform 210, the container orchestration platform operator service 214 (FIGS. 2B and 3B) and the container orchestration platform server 212 (FIGS. 2B and 3B) of the on-premises container orchestration platform 210 request or poll a cloud provider 250 (FIGS. 2B and 3B) (e.g., at periodic or aperiodic intervals), as described below, to provide a cloud resource configuration.

Example FIG. 7 shows a process implemented by the container orchestration platform operator service 214, the container orchestration platform server 212 and a cloud provider 250. In the illustrated example workflow 700, at event 702 the container orchestration platform operator service 214 sends a “Get VPC Details” request in a cloud-provider-agnostic format to the container orchestration platform server 212. At event 704, the example container orchestration platform server 212 sends a “Get VPC” request to the cloud provider 250 in a cloud-provider-specific format of the cloud provider 250. The example cloud provider 250 responds at event 706 by sending a response that includes VPC “resource details” in the cloud-provider-specific format to the container orchestration platform server 212. The example VPC “resource details” response includes VPC resource configurations of one or more VPC resources provided by the cloud provider 250. The example container orchestration platform server 212 receives the VPC “resource details”, converts the VPC “resource details” to “VPC state details” in the cloud-provider-agnostic format so that it can be read and interpreted by the container orchestration platform operator service 214, and forwards the “VPC state details” to the container orchestration platform operator service 214 at event 708. At event 710, the container orchestration platform operator service 214 checks the “VPC state details” for drift (e.g., changes) in the VPC resource configurations of the VPC resource(s) relative to a desired configuration or target configuration. For example, a desired or target configuration is specified in the VPC input specification 400 (FIG. 4), and the container orchestration platform operator service 214 checks the “VPC state details” for drift by comparing the “VPC state details” to the desired or target configuration in the VPC input specification 400. At event 712, the example container orchestration platform operator service 214 sends an “Update VPC details” message in a cloud-provider-agnostic format to the container orchestration platform server 212. At event 714, the example container orchestration platform server 212 converts the “Update VPC details” from the cloud-provider-agnostic format to an “Update VPC” message in a cloud-provider-specific format for the cloud provider 250 and sends the “Update VPC” message to the cloud provider 250. In the illustrated example, the “Update VPC” message specifies changes to one or more configuration parameters for use in updating one or more configuration(s) of one or more VPC resource(s) provided by the cloud provider 250. After the example cloud provider 250 has updated the configuration(s) of the VPC resources to satisfy the desired or target configuration(s), at event 716, the cloud provider 250 sends “Resource Details” to the container orchestration platform server 212. In the illustrated example, the “Resource Details” message is organized in the cloud-provider-specific format of the cloud provider 250 and includes VPC resource configurations of one or more VPC resources provided by the cloud provider 250 after the cloud provider 250 has updated one or more configurations of the one or more VPC resources. The example container orchestration platform server 212 converts the “Resource Details” from the cloud-provider-specific format to “VPC State Details” in the cloud-provider-agnostic format and forwards the “VPC State Details” to the container orchestration platform operator service 214 at event 718.

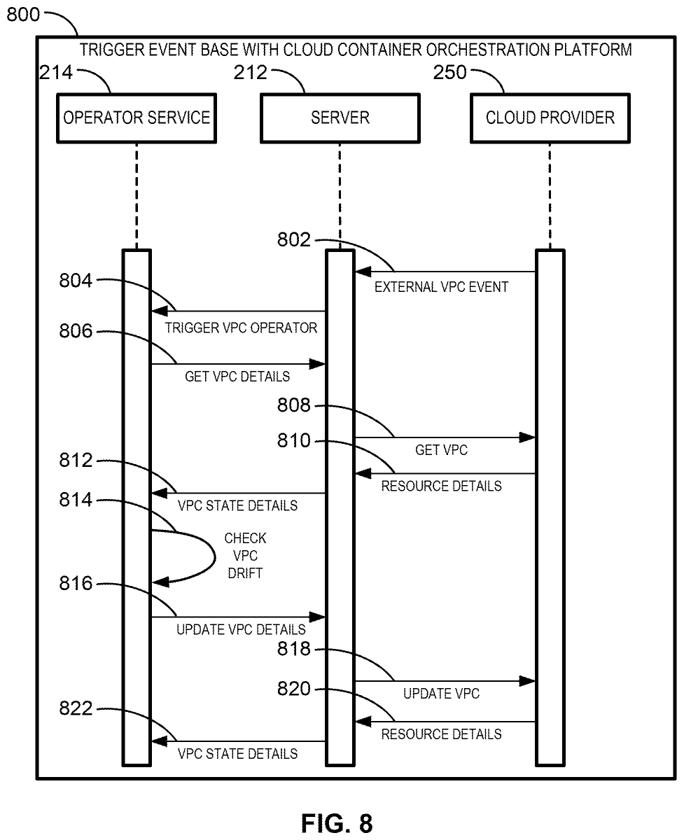

FIG. 8 is an interaction diagram of an example workflow 800 to enforce a cloud resource desired state (e.g., a cloud resource target state) based on a trigger event using the cloud container orchestration platform 210 (FIG. 2A). The illustrated example 800 shows a process that may be implemented by the container orchestration platform operator service 214 and the container orchestration platform server 212 of the cloud container orchestration platform 210 of FIG. 2A in cooperation with a cloud provider 250 of FIG. 2A. To enforce a desired state or target state of one or more cloud resources, the cloud container orchestration platform 210 monitors for a trigger event from the cloud provider 250. The illustrated example workflow 800 begins at event 802 when the container orchestration platform server 212 receives an “External VPC Event” message from the cloud provider 250 in a cloud-provider-specific format of the cloud provider 250. At event 804, the example container orchestration platform server 212 sends a “Trigger VPC Operator” message to the container orchestration platform operator service 214 in a cloud-provider-agnostic format so that it can be read and interpreted by the container orchestration platform operator service 214. At event 806, the example container orchestration platform operator service 214 responds by sending a “Get VPC details” request in the cloud-provider-agnostic format to the container orchestration platform server 212. At event 808, the container orchestration platform server 212 sends a “Get VPC” request in the cloud-provider-specific format to the cloud provider 250. At event 810, the cloud provider 250 responds by sending VPC “resource details” in the cloud-provider-specific format to the container orchestration platform server 212. The example VPC “resource details” response includes VPC resource configurations of one or more VPC resources provided by the cloud provider 250. At event 812, the container orchestration platform server 212 converts the VPC “resource details” from the cloud-provider-specific format to “VPC state details” in the cloud-provider-agnostic format and forwards the “VPC state details” to the container orchestration platform operator service 214. At event 814, the container orchestration platform operator service 214 checks the “VPC state details” for drift (e.g., changes) in the VPC resource configurations of the VPC resource(s) relative to a desired configuration or target configuration. For example, a desired or target configuration is specified in the VPC input specification 400 (FIG. 4), and the container orchestration platform operator service 214 checks the “VPC state details” for drift by comparing the “VPC state details” to the desired or target configuration in the VPC input specification 400. At event 816, the example container orchestration platform operator service 214 sends an “Update VPC details” message in the cloud-provider-agnostic format to the container orchestration platform server 212. At event 818, the container orchestration platform server 212 converts the “Update VPC details” message from the cloud-provider-agnostic format to an “Update VPC” message in the cloud-provider-specific format and sends the “Update VPC” message to the cloud provider 250. In the illustrated example, the “Update VPC” message specifies changes to one or more configuration parameters for use in updating one or more configuration(s) of one or more VPC resource(s) provided by the cloud provider 250. After the example cloud provider 250 has updated the configuration(s) of the VPC resources to satisfy the desired or target configuration(s), at event 820, the cloud provider 250 sends “Resource Details” to the container orchestration platform server 212. In the illustrated example, the “Resource Details” message is in the cloud-provider-specific format and includes VPC resource configurations of one or more VPC resources provided by the cloud provider 250 after the cloud provider 250 has updated one or more configurations of the one or more VPC resources. The example container orchestration platform server 212 converts the “Resource Details” message from the cloud-provider-specific format to “VPC State Details” in the cloud-provider-agnostic format and forwards the “VPC State Details” to the container orchestration platform operator service 214 at event 822.

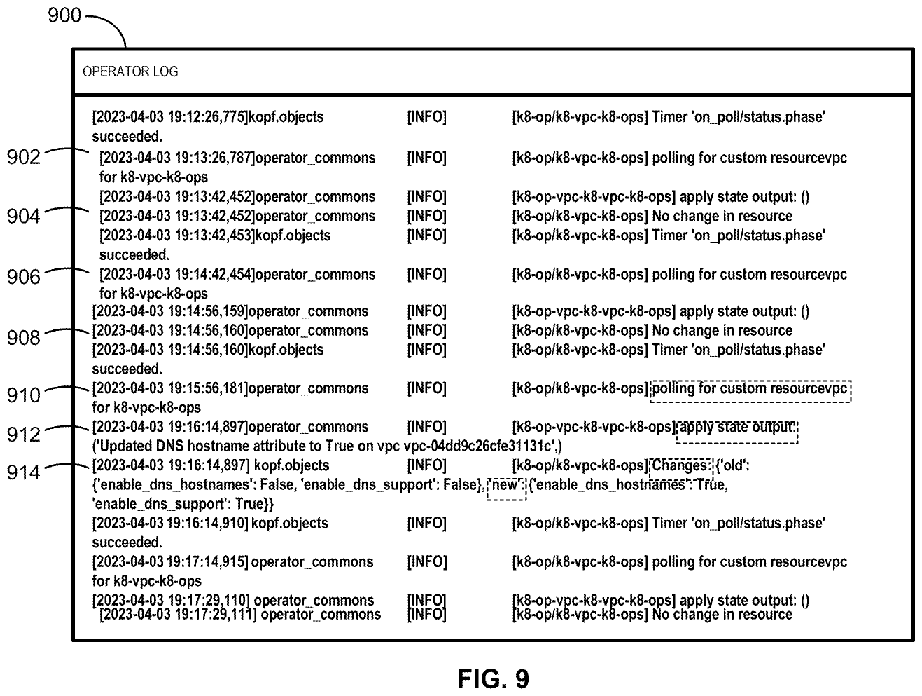

FIG. 9 is an example container orchestration platform operator log 900. The example container orchestration platform operator service 214 of FIG. 2 can be deployed on-premises or in the cloud. It is used to enforce configurations of cloud resources to comply with a desired state or target state. To do this, the example container orchestration platform operator service 214 compares a cloud resource configuration against a desired state configuration (e.g., a target state configuration). If there is a drift or difference in the cloud resource configuration relative to the desired or target state configuration, the example container orchestration platform operator service 214 triggers an update on one or more corresponding cloud resources. After the one or more cloud resources are updated, the example container orchestration platform operator service 214 updates target state resource specification status details. In examples disclosed herein, target state resource specification details include a status of the cloud resource configuration specification defined in the VPC input specification 400 (FIG. 4). The example container orchestration platform operator log 900 shows logged requesting events or polling events by the container orchestration platform operator service 214 for a custom resource configuration at 902, 906 and 910. At 902, there was no changes in the one or more cloud resources as shown at 904. At 906, there were also no changes to the one or more cloud resources as shown at 908. A drift is identified at reference number 910 corresponding to a logged event at which the container orchestration platform operator service 214 polls for the custom resource configuration. The example container orchestration platform operator service 214 updates the target state resource configuration at 912. The example container orchestration platform operator log 900 shows changes to an updated resource configuration specification at 914.

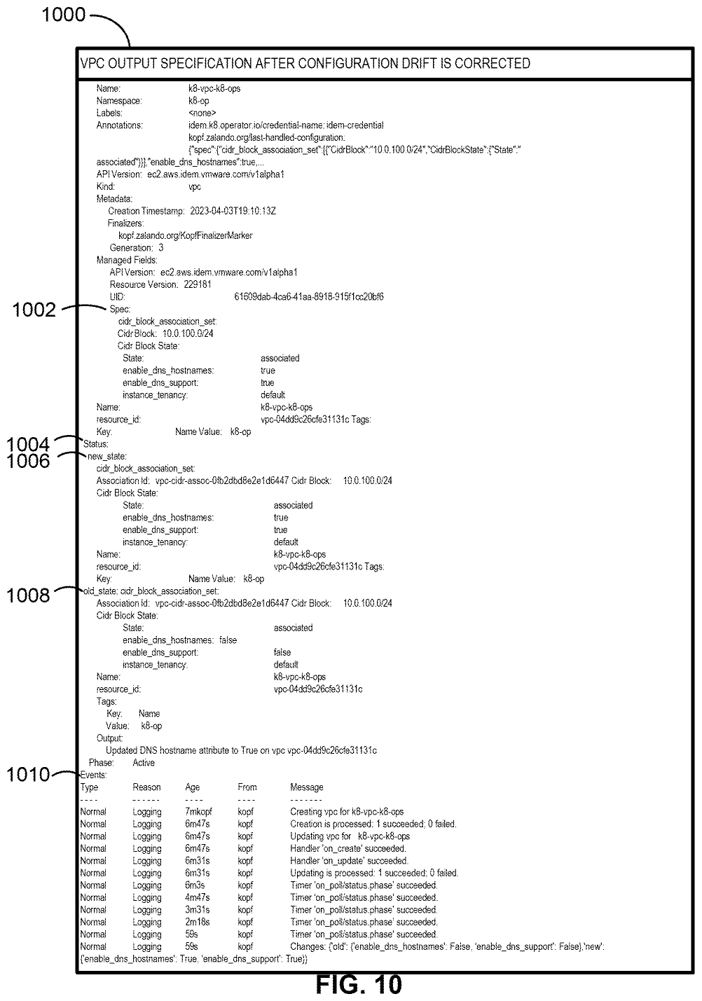

FIG. 10 is an example VPC output specification 1000 after a drift in one or more cloud resources has been corrected. The example VPC output specification 1000 corresponds to the cloud resources created using the VPC input specification 400 of FIG. 4. The example VPC output specification 1000 includes a status section 1004 and an event section 1010. The example status section 1004 shows a new_state section 1006 which is a latest resource configuration. An old_state section 1008 shows a previous resource configuration for the one or more cloud resources. In this illustrated example, a configuration change is shown for enable_dns_hostnames and enable_dns_support parameter. The configuration states of both of these parameters changed from “false” to “true”. The example VPC output specification 1000 shows the generated events at the event section 1010. The events section 1010 shows that the generated events were handled and shows the logs for those events.

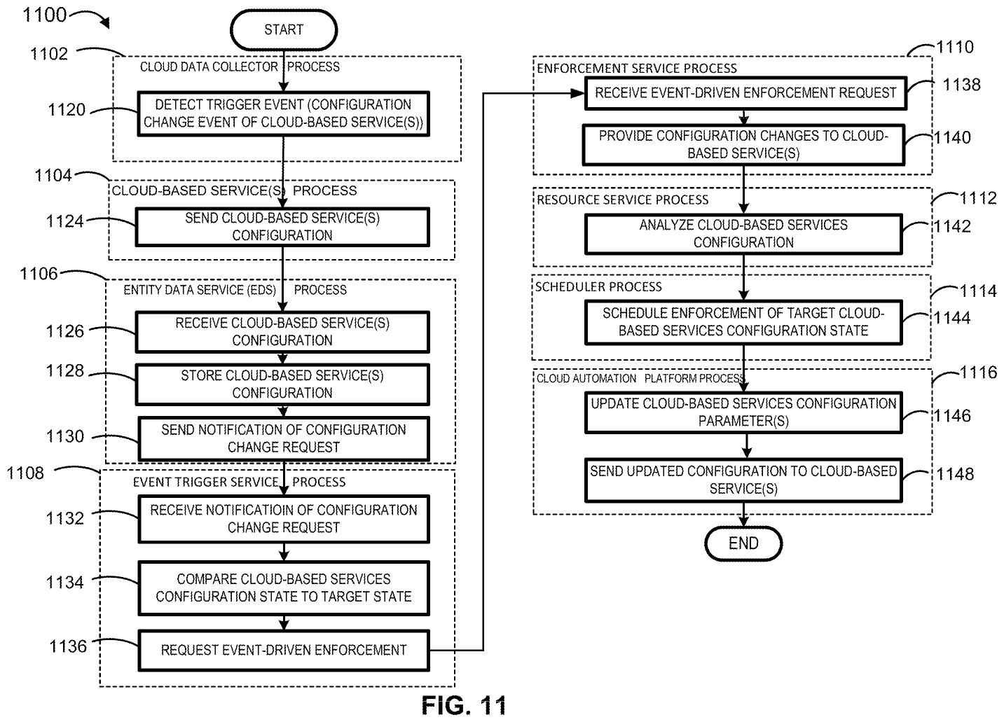

Flowcharts representative of example machine readable instructions, which may be executed by programmable circuitry to implement and/or instantiate the cloud resource configuration manager 101 of FIGS. 1-3 and/or representative of example operations which may be performed by programmable circuitry to implement and/or instantiate the cloud resource configuration manager 101 of FIGS. 1-3, are shown in FIGS. 11, 12 and 13. The machine readable instructions may be one or more executable programs or portion(s) of one or more executable programs for execution by programmable circuitry such as the programmable circuitry 1412 shown in the example processor platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine readable instructions cause an operation, a task, etc., to be carried out and/or performed in an automated manner in the real world. As used herein, “automated” means without human involvement.

The programs may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entireties of the programs and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example programs are described with reference to the flowcharts illustrated in FIGS. 11-13, many other methods of implementing the example cloud resource configuration manager 101 may alternatively be used. For example, the order of execution of the blocks of the flowcharts may be changed, and/or some of the blocks described may be changed, eliminated, or combined. Additionally or alternatively, any or all of the blocks of the flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as those described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 11-13 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 11 is a flowchart representative of example machine readable instructions and/or example operations 1100 that may be executed, instantiated, and/or performed by programmable circuitry to update a cloud resource configuration based on a trigger event using the cloud collection framework 104, the core enforcement framework 109 and the configuration service 120 of FIG. 1A. In the illustrated example of FIG. 11, the flowchart shows a cloud data collector process 1102, a cloud-based service(s) process 1104, an entity data service (EDS) process 1106, an event trigger service process 1108, an enforcement service process 1110, a resource service process 1112, a scheduler process 1114, and a cloud automation platform process 1116. In the illustrated example, the cloud data collector process 1102 may be implemented by the cloud data collector 106 of FIG. 1A. The example cloud based-service(s) process 1104 may be implemented by the cloud-based service(s) 102 of FIG. 1A. The example entity data service (EDS) process 1106 may be implemented by the entity data service (EDS) 108 of FIG. 1A. The example event trigger service process 1108 may be implemented by the event trigger service 110 of FIG. 1A. The example enforcement service process 1110 may be implemented by the enforcement service 112 of FIG. 1A. The example resource service process 1112 may be implemented by the resource service 114 of FIG. 1A. The example scheduler process 1114 may be implemented by the scheduler 116 of FIG. 1A. The example cloud automation platform process 1116 may be implemented by the cloud automation platform 122 (IDEM services) of FIG. 1A.

The example processes of FIG. 11 are described in connection with FIG. 1A as interactions between the cloud-based service(s) 102, the cloud collection framework 104, the core enforcement framework 109 and the configuration service 120 deployed in the cloud. The example cloud collection framework 104 uses a trigger event from the cloud based service(s) 102 and poll requests sent to cloud based service(s) 102 to manage cloud resource configuration states of one or more cloud resources. In such examples, the core enforcement framework 109 monitors for trigger events caused by a monitoring operation performed on a cloud resource configuration state to detect changes in cloud resource configurations of the one or more cloud resources.

The example machine-readable instructions and/or the example operations 1100 of FIG. 11 begin at block 1120, at which the cloud data collector 106 (FIG. 1A) detects a trigger event, such as a rule change and/or a configuration change corresponding to the cloud-based service(s) 102. A configuration change or a configuration drift exists when a current cloud-based service configuration state (e.g., a current state) of a cloud-based service 102 does not match a desired or target state configuration. When the trigger event occurs at block 1120, the example cloud-based service(s) 102 sends the current cloud-based service configuration to the entity data service (EDS) 108 (block 1124).

The example EDS 108 receives the current cloud-based service configuration (block 1126) and stores the current cloud-based service configuration (block 1128). The example EDS 108 sends notification of a cloud-based service configuration change request (block 1130) to the event trigger service 110.

The example event trigger service 110 receives the notification of cloud-based service configuration change request (block 1132) and compares the current cloud-based service configuration state to a desired or target state (block 1134). The example event trigger service 110 requests an event-driven enforcement (block 1136) of the cloud-based service configuration.

The example enforcement service 112 receives the event-driven enforcement request (block 1138). The example enforcement service 112 provides configuration changes to the cloud-based service(s) 102 (block 1140) based on the event-driven enforcement request received from the event trigger service 110.

At block 1142, the example resource service 114 analyzes and/or manages metadata representative of the cloud-based services configuration and used to manage the cloud-based service(s) 102. For example, the metadata corresponds to settings, access information and/or configurations of the cloud-based service(s) 102.

At block 1144, the example scheduler 116 directs and/or manages scheduled implementations, configuration changes, enforcements and/or updates (e.g., periodic updates) of the cloud-based service(s) 102. For example, the scheduler 116 can schedule the enforcements to control and/or direct a desired state of the cloud-based service(s) 102. This causes enforcements to be provided to the example cloud automation platform (IDEM service) 122 according to the scheduling.

At block 1146, the example cloud automation platform 122 updates one or more cloud-based service configuration parameter(s) to implement the desired or target state with respect to the cloud-based service(s) 102. The example cloud automation platform 122 sends the updated configuration to the cloud-based service(s) 102 (block 1148). The example instructions and/or operations 1100 of FIG. 11 end.

FIG. 12 is a flowchart representative of example machine readable instructions and/or example operations 1200 that may be executed, instantiated, and/or performed by programmable circuitry to update a cloud resource configuration based on a trigger event using a cloud container orchestration platform 210 (FIG. 2A). In the illustrated example of FIG. 12, the flowchart shows a container orchestration platform operator process 1202, a container orchestration platform server process 1204, a cloud provider process 1206, and a cloud automation platform process 1208. In the illustrated example, the container orchestration platform operator process 1202 may be implemented by the container orchestration platform operator service 214 of FIGS. 2 and 3. The example container orchestration platform server process 1204 may be implemented by the container orchestration platform server 212 of FIGS. 2 and 3. The example cloud provider process 1206 may be implemented by a cloud provider 250 of FIGS. 2 and 3. The example cloud automation platform process 1208 may be implemented by the cloud automation platform 218 of FIGS. 2 and 3.

The example processes of FIG. 12 are described in connection with FIGS. 3 and 8 as interactions between the container orchestration platform server 212, the container orchestration platform operator service 214 and the cloud provider 250 for instances in which the container orchestration platform 210 is deployed in the cloud. When deployed in the cloud, the example container orchestration platform 210 uses trigger event from cloud provider(s) 250 to manage cloud resource configuration states of one or more cloud resources. In such examples, the cloud container orchestration platform 210 monitors for trigger events caused by a monitoring operation performed on a cloud resource configuration state to detect changes in cloud resource configurations of the one or more cloud resources.

The example machine-readable instructions and/or the example operations 1200 of FIG. 12 begin at block 1210, at which the cloud provider 250 (FIG. 3A) detects a change made to resource configuration information. The example cloud provider 250 sends a trigger event or alert to the container orchestration platform server 212 (FIG. 3A) (block 1212) via the communication interface 322 (FIG. 3A) implemented by the container orchestration platform API 216 (FIG. 3A). The trigger event is received (block 1214) at the example container orchestration platform server 212 in a cloud-provider-specific format. The example container orchestration platform server 212 converts the trigger event from a cloud-provider-specific format to a cloud-provider-agnostic format (block 1215). The example container orchestration platform server 212 triggers (block 1216) the container orchestration platform operator service 214 (FIG. 3) in the cloud by, for example, sending the converted trigger event to the container orchestration platform operator service 214. The example cloud resource configuration requester 314 (FIG. 3A) sends a request for the cloud resource configuration state in the cloud-provider-agnostic format (block 1218). The request is received (block 1220) at the example container orchestration platform server 212. The example container orchestration platform server 212 converts the cloud resource configuration request from the cloud-provider-agnostic format to the cloud-provider-specific format (block 1221) for a corresponding one of the cloud providers 250. The example container orchestration platform server 212 sends the cloud resource configuration request in the cloud-provider-specific format (block 1222) to the cloud provider 250 via the communication interface 322 implemented by the container orchestration platform API 216. The example cloud provider 250 receives the cloud resource configuration request (block 1224). The example cloud provider 250 sends current cloud resource configuration information (block 1226) of one or more cloud resources to the container orchestration platform server 212 via the communication interface 322 implemented by the container orchestration platform API 216. The example container orchestration platform server 212 receives the current cloud resource configuration information in the cloud-provider-specific format (block 1228). The example cloud resource information converter 306 (FIG. 3A) converts the current cloud resource configuration information to a current cloud resource configuration state (block 1230). For example, the current cloud resource configuration information is converted from the cloud-provider-specific format of the cloud provider 250 to current cloud resource configuration state in the cloud-provider-agnostic format (e.g., SLS code) to be used by the cloud automation platform 218. The example container orchestration platform server 212 sends the current cloud resource configuration state in the cloud-provider-agnostic format (block 1232) to the container orchestration platform operator service 214.

The example container orchestration platform operator service 214 receives the current cloud resource configuration state (block 1234). The example comparator 310 (FIG. 3A) compares the current cloud resource configuration state to a desired or target configuration (block 1236). The example cloud automation platform 218 determines whether resource configuration drift is detected (block 1238) in the cloud resource configuration state based on the comparison of block 1236. A configuration resource configuration drift exists when a current configuration state (e.g., a current state) of a resource does not match an Infrastructure as a Code (IaC) configuration. Such IaC configuration can be based on a target resource configuration data file (e.g., the VPC input specification 400 of FIG. 4) specified by the authenticated operator 220 (FIG. 2A). If drift is detected, the example cloud automation platform 218 identifies differences in the configuration parameters (block 1240) that correspond to the drift. The example automatic parameter updater 318 (FIG. 3A) generates updates for drifted ones of the configuration parameters (block 1242). In addition, the example automatic parameter updater 318 writes the updates for the configuration parameters in a cloud resource configuration specification (block 1244). For example, the automatic parameter updater 318 updates a cloud resource configuration specification structured similar to the VPC resource output specification 500 of FIG. 5 to specify updated values for the drifted ones of the configuration parameters that are to be updated by the cloud provider 250 for one or more corresponding cloud resources that have drifted from a desired or target configuration. The example cloud automation platform 218 sends the cloud resource configuration specification (block 1246) to the container orchestration platform server 212.

The example container orchestration platform server 212 receives the cloud resource configuration specification in the cloud-provider-agnostic format (block 1248). The example container orchestration platform server 212 converts the cloud resource configuration specification from the cloud-provider-agnostic format to the cloud-provider-specific format (block 1249) for a corresponding one of the cloud providers 250. The example container orchestration platform server 212 sends the cloud resource configuration specification in the cloud-provider-specific format (block 1250) to the cloud provider 250. The example cloud provider 250 updates the cloud resource configuration (block 1252) based on the updated cloud resource configuration specification to achieve compliance with a desired or target configuration. For example, the cloud provider 250 updates the cloud resource configuration by changing the cloud resource configuration to match the target cloud resource configuration specification so that a configuration state of a corresponding cloud resource is in compliance with the desired or target cloud resource state.

Control returns to block 1226 at which the cloud provider 250 sends the updated cloud resource configuration information to the container orchestration platform server 212. In this manner, the example container orchestration platform operator service 214 and the example cloud automation platform can analyze the updated cloud resource configuration information for drift. If the cloud automation platform 218 does not detect a drift for the cloud resource configuration at block 1238, the example instructions and/or operations of FIG. 12 end.

FIG. 13 is a flowchart representative of example machine readable instructions and/or example operations 1300 that may be executed, instantiated, and/or performed by programmable circuitry to update a cloud resource configuration based on polling using an on-premises installation of the container orchestration platform 210 (FIG. 2B). In the illustrated example of FIG. 13, the flowchart shows a container orchestration platform operator process 1302, a container orchestration platform server process 1304, a cloud provider process 1306, and a cloud automation platform process 1308. In the illustrated example, the container orchestration platform operator process 1302 may be implemented by the container orchestration platform operator service 214 of FIGS. 2B and 3B. The example container orchestration platform server process 1304 may be implemented by the container orchestration platform server 212 of FIGS. 2B and 3B. The example cloud provider process 1306 may be implemented by the cloud provider 250 of FIGS. 2B and 3B. The example cloud automation platform process 1308 may be implemented by the cloud automation platform 218 of FIGS. 2B and 3B.

The example processes of FIG. 13 are described in connection with FIGS. 3B and 7 as interactions between the container orchestration platform server 212, the container orchestration platform operator service 214 and a cloud provider 250 for instances in which the container orchestration platform 210 is deployed on-premises. When deployed on-premises, the example container orchestration platform 210 uses polling-based (e.g., request-based) enforcement to manage cloud resource configuration states. In such examples, the container orchestration platform 210 polls for or requests a cloud resource configuration state of one or more cloud resources to detect any drift (e.g., change) in current cloud resource configurations of the one or more cloud resources relative to target or desired configurations.

The example machine-readable instructions and/or operations 1300 of FIG. 13 begin at block 1310, at which the cloud resource configuration requester 314 (FIG. 3B) polls for or requests a cloud resource configuration state. In some examples, the clock 316 (FIG. 3B) is used to cause the cloud resource configuration requester 314 to request or poll for the cloud resource configuration state at periodic intervals. In some examples, the polling interval is configured as one minute. However, any other interval durations may be used so that the cloud resource configuration requester 314 requests or polls for the cloud resource configuration state at such intervals. In other examples, the cloud resource configuration requester 314 can request or poll for the cloud resource configuration state at aperiodic intervals.

A cloud resource configuration request in a cloud-provider-agnostic format is received (block 1312) at the example container orchestration platform server 212. The example container orchestration platform server 212 converts the cloud resource configuration request from a cloud-provider-agnostic format to a cloud-provider-specific format (block 1313) for a corresponding one of the cloud providers 250.). The example container orchestration platform server 212 sends the cloud resource configuration request (block 1314) to the cloud provider 250 via the communication interface 322 (FIG. 3B) implemented by the container orchestration platform API 216 (FIG. 3B). The example cloud provider 250 receives the cloud resource configuration request (block 1316). The example cloud provider 250 sends current cloud resource configuration information (block 1318) of one or more cloud resources to the container orchestration platform server 212. The example container orchestration platform server 212 receives the current cloud resource configuration information in a cloud-provider-specific format (block 1320) via the communication interface 322 implemented by the container orchestration platform API 216. The example cloud resource information converter 306 (FIG. 3) converts the current cloud resource configuration information to a cloud resource configuration state (block 1322). For example, the cloud resource information converter 306 converts the current cloud resource configuration information from the cloud-provider-specific format of the cloud provider 250 to a current cloud resource configuration state in a cloud-provider-agnostic format (e.g., SLS code) to be used by the cloud automation platform 218. The example container orchestration platform server 212 sends the current cloud resource configuration state (block 1324) to the container orchestration platform operator service 214.

The example container orchestration platform operator service 214 receives the current cloud resource configuration state (block 1326). The example comparator 310 (FIG. 3B) compares the current cloud resource configuration state to a desired or target configuration (block 1328). The example cloud automation platform 218 determines whether resource configuration drift is detected (block 1330) in the current cloud resource configuration state based on the comparison of block 1328. A resource configuration drift exists when a current configuration state (e.g., a current state) of a resource infrastructure does not match a target or desired Infrastructure as Code (IaC) configuration. Such IaC configuration can be based on a target resource configuration data file (e.g., the VPC input specification 400 of FIG. 4) specified by the authenticated operator 220 (FIG. 2). If drift is detected, the example cloud automation platform 218 identifies differences in the configuration parameters (block 1332) that correspond to the drift. The example automatic parameter updater 318 (FIG. 3B) generates updates for drifted ones of the configuration parameters (block 1334). In addition, the example automatic parameter updater 318 writes the updates for the configuration parameters in a cloud resource configuration specification (block 1336). For example, the automatic parameter updater 318 updates a cloud resource configuration specification structured similar to the VPC resource input specification 400 of FIG. 4 to specify updated values for the drifted ones of the configuration parameters that are to be updated by the cloud provider 250 for one or more corresponding cloud resources that have drifted from a desired or target configuration. The example cloud automation platform 218 sends the cloud resource configuration specification in a cloud-provider-agnostic format (block 1338) to the container orchestration platform server 212.

The example container orchestration platform server 212 receives the cloud resource configuration specification in the cloud-provider-agnostic format (block 1340). The example container orchestration platform server 212 converts the cloud resource configuration specification from the cloud-provider-agnostic format to a cloud-provider-specific format (block 1341) for a corresponding one of the cloud providers 250. The example container orchestration platform server 212 sends the cloud resource configuration specification in the cloud-provider-specific format (block 1342) to the cloud provider 250. The example cloud provider 250 updates the cloud resource configuration (block 1344) based on the updated cloud resource configuration specification to achieve compliance with a desired or target configuration. For example, the cloud provider 250 updates the cloud resource configuration by changing the cloud resource configuration to match the target cloud resource configuration specification so that a configuration state of a corresponding cloud resource is in compliance with the desired or target cloud resource state.

Control returns to block 1318 at which the cloud provider 250 sends the updated cloud resource configuration information to the container orchestration platform server 212. In this manner, the example container orchestration platform operator service 214 and the example cloud automation platform 218 can analyze the updated cloud resource configuration information for drift. If the cloud automation platform 218 does not detect a drift for the cloud resource configuration at block 1330, the example instructions and/or operations 1300 of FIG. 13 end.

FIG. 14 is a block diagram of an example programmable circuitry platform 1400 structured to execute and/or instantiate the example machine-readable instructions and/or the example operations of FIGS. 11-13 to implement the cloud resource configuration manager 101 of FIGS. 1-3. The programmable circuitry platform 1400 can be, for example, a server, a personal computer, a workstation, a self-learning machine (e.g., a neural network), or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the event detector 302, the cloud resource configuration controller 304, the cloud resource information converter 306, the message generator 308, the comparator 310, the cloud resource configuration specification updater 312, the cloud resource configuration requester 314, the clock 316, the automatic parameter updater 318, the cloud resource configuration updater 320, and the communication interface 322 of FIG. 3.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, and 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, and 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, a keyboard, a button, a mouse, a touchscreen, a trackpad, and/or a trackball.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, and/or a touchscreen etc.). The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In some examples, the interface circuitry 1420 implements at least a portion of the communication interface 322 of FIG. 3.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1432, which may be implemented by the machine readable instructions of FIGS. 11-13 may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 11-13 to effectively instantiate the circuitry of FIG. 2 as logic circuits to perform operations corresponding to those machine readable instructions. In some such examples, the circuitry of FIG. 3 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 11-13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine readable instructions represented by the flowchart(s) of FIGS. 11-13 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 11-13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 11 and 12. As such, the FPGA circuitry 1600 may be configured and/or structured to effectively instantiate some or all of the operations/functions corresponding to the machine readable instructions of the flowchart(s) of FIGS. 11-13 as dedicated logic circuits to perform the operations/functions corresponding to those software instructions in a dedicated manner analogous to an ASIC. Therefore, the FPGA circuitry 1600 may perform the operations/functions corresponding to the some or all of the machine readable instructions of FIGS. 11-13 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine readable instructions of FIGS. 11-13 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine readable instructions represented by the flowchart(s) of FIGS. 11-13 to perform first operation(s)/function(s), the FPGA circuitry 1600 of FIG. 16 may be configured and/or structured to perform second operation(s)/function(s) corresponding to a second portion of the machine readable instructions represented by the flowcharts of FIG. 11-13, and/or an ASIC may be configured and/or structured to perform third operation(s)/function(s) corresponding to a third portion of the machine readable instructions represented by the flowcharts of FIGS. 11-13.

It should be understood that some or all of the circuitry of FIG. 3 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1500 of FIG. 15 may execute machine readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 3 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

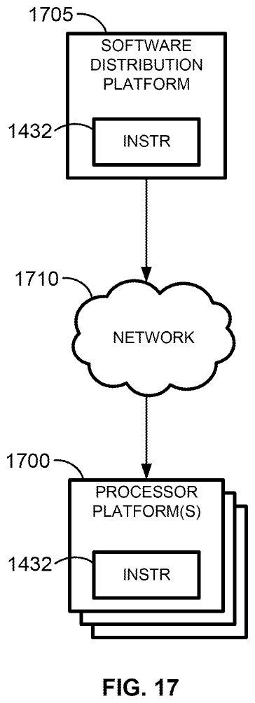

A block diagram illustrating an example software distribution platform 1605 to distribute software such as the example machine readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions of FIGS. 11-13, as described above. The one or more servers of the example software distribution platform 1705 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions of FIG. 11-13, may be downloaded to the example programmable circuitry platform 1400, which is to execute the machine readable instructions 1432 to implement the cloud resource configuration manager 101 of FIGS. 1-3. In some examples, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that maintain cloud resource configurations in a target or desired state. Disclosed systems, apparatus, articles of manufacture, and methods improve the efficiency of using a computing device by automatically detecting and fixing cloud resource configuration drift as it occurs. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to maintain cloud resource configurations in a target or desired state are disclosed herein. Further examples and combinations thereof include the following: Example 1 includes a system comprising interface circuitry, machine-readable instructions, and programmable circuitry to at least one of execute or instantiate the machine-readable instructions to compare a cloud resource configuration state with a cloud resource target configuration, generate an updated cloud resource configuration specification based on a difference between the cloud resource configuration state and the cloud resource target configuration, and cause an update of a cloud resource configuration parameter in a cloud provider based on the updated cloud resource configuration specification.

Example 2 includes the system of example 1, wherein the programmable circuitry is to request the cloud resource configuration state.

Example 3 includes the system of example 1, wherein the programmable circuitry is to poll for the cloud resource configuration state.

Example 4 includes the system of example 1, wherein the programmable circuitry is to detect a trigger event from the cloud provider, the trigger event caused by a change in the cloud resource configuration state.

Example 5 includes the system of example 4, wherein the trigger event is to cause the programmable circuitry to at least one of 1) create the cloud resource configuration parameter, 2) update the cloud resource configuration state, or 3) ignore the trigger event if there is no difference between the cloud resource configuration state and the cloud resource target configuration.

Example 6 includes the system of example 1, wherein the cloud resource configuration state is associated with current parameter settings.

Example 7 includes the system of example 6, wherein the current parameter settings include at least one of a specification parameter, a status parameter, or an event parameter.

Example 8 includes the system of example 1, wherein the programmable circuitry is to cause a cloud automation platform to select parameter settings to update in the cloud resource configuration specification.

Example 9 includes the system of example 1, wherein the programmable circuitry is to cause transmission of the updated cloud resource configuration specification to a container orchestration platform server.

Example 10 includes the system of example 1, wherein a request for the cloud resource configuration state causes the programmable circuitry to convert cloud resource configuration information from the cloud provider to the cloud resource configuration state, the cloud resource configuration information in a cloud-provider-specific format, the cloud resource configuration state in a cloud-provider-agnostic format.

Example 11 includes a non-transitory machine-readable medium comprising instruction to cause programmable circuitry to compare a cloud resource configuration state with a cloud resource target configuration, update a cloud resource configuration specification based on a difference between the cloud resource configuration state and the cloud resource target configuration, and cause an update of a cloud resource configuration parameter in a cloud provider based on an updated cloud resource configuration specification.

Example 12 includes the non-transitory machine-readable medium of example 11, wherein the instructions are to cause the programmable circuitry to request the cloud resource configuration state.

Example 13 includes the non-transitory machine-readable medium of example 11, wherein the instructions are to cause the programmable circuitry to compare the cloud resource configuration state to the cloud resource target configuration after polling for the cloud resource configuration state.

Example 14 includes the non-transitory machine-readable medium of example 11, wherein the instructions are to cause the programmable circuitry to compare the cloud resource configuration state to the cloud resource target configuration after detecting a trigger event from the cloud provider, the trigger event caused by a change in the cloud resource configuration state.

Example 15 includes the non-transitory machine-readable medium of example 14, wherein the instructions are to cause the programmable circuitry to respond to the trigger event by at least one of 1) creating the cloud resource configuration parameter, 2) updating the cloud resource configuration state, or 3) ignoring the trigger event if there is no difference between the cloud resource configuration state and the cloud resource target configuration.

Example 16 includes the non-transitory machine-readable medium of example 11, wherein the cloud resource configuration state includes current parameter settings.

Example 17 includes the non-transitory machine-readable medium of example 16, wherein the current parameter settings include at least one of a specification parameter, a status parameter, or an event parameter.

Example 18 includes the non-transitory machine-readable medium of example 11, wherein the instructions are to cause the programmable circuitry to cause a cloud automation platform to select parameter settings to update in the cloud resource configuration specification.

Example 19 includes the non-transitory machine-readable medium of example 11, wherein the instructions are to cause the programmable circuitry to cause a transmission of the cloud resource configuration specification to a container orchestration platform server.

Example 20 includes the non-transitory machine-readable medium of example 11, wherein after a request for the cloud resource configuration state, the instructions are to cause the programmable circuitry to convert cloud resource configuration information from the cloud provider to the cloud resource configuration state, the cloud resource configuration information in a cloud-provider-specific format, the cloud resource configuration state in a cloud-provider-agnostic format.

Example 21 includes a method to manage a configuration of a cloud resource, the method comprising comparing a cloud resource configuration state with a cloud resource target configuration, updating, with programmable circuitry, a cloud resource configuration specification based on a difference between the cloud resource configuration state and the cloud resource target configuration, and causing an update of a cloud resource configuration parameter in a cloud provider.

Example 22 includes the method of example 21, further including requesting the cloud resource configuration state.

Example 23 includes the method of example 21, further including comparing the cloud resource configuration state to the cloud resource target configuration after polling for the cloud resource configuration state.

Example 24 includes the method of example 21, further including comparing the cloud resource configuration state to the cloud resource target configuration after detecting a trigger event from the cloud provider, the trigger event caused by a change in the cloud resource configuration state.

Example 25 includes the method of example 24, further including, after the trigger event, at least one of 1) creating the cloud resource configuration parameter, 2) updating the cloud resource configuration state, or 3) ignoring the trigger event if there is no difference between the cloud resource configuration state and the cloud resource target configuration.

Example 26 includes the method of example 21, wherein the cloud resource configuration state includes current parameter settings.

Example 27 includes the method of example 26, wherein the current parameter settings include at least one of a specification parameter, a status parameter, or an event parameter.

Example 28 includes the method of example 21, further including causing a cloud automation platform to select parameter settings to update in the cloud resource configuration specification.

Example 29 includes the method of example 21, further including transmitting an updated cloud resource configuration specification to a container orchestration platform server.

Example 30 includes the method of example 21, further including converting cloud resource configuration information from the cloud provider to the cloud resource configuration state, the cloud resource configuration information in a cloud-provider-specific format, the cloud resource configuration state in a cloud-provider-agnostic format.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
interface circuitry;
machine-readable instructions; and
programmable circuitry to at least one of execute or instantiate the machine-readable instructions to:
compare a cloud resource configuration state with a cloud resource target configuration;
generate an updated cloud resource configuration specification based on a difference between the cloud resource configuration state and the cloud resource target configuration; and
cause an update of a cloud resource configuration parameter in a cloud provider based on the updated cloud resource configuration specification.

2. The system of claim 1, wherein the programmable circuitry is to request the cloud resource configuration state.

3. The system of claim 1, wherein the programmable circuitry is to poll for the cloud resource configuration state.

4. The system of claim 1, wherein the programmable circuitry is to detect a trigger event from the cloud provider, the trigger event caused by a change in the cloud resource configuration state.

5. The system of claim 4, wherein the trigger event is to cause the programmable circuitry to at least one of 1) create the cloud resource configuration parameter, 2) update the cloud resource configuration state, or 3) ignore the trigger event if there is no difference between the cloud resource configuration state and the cloud resource target configuration.

6. The system of claim 1, wherein the cloud resource configuration state is associated with current parameter settings.

7. The system of claim 6, wherein the current parameter settings include at least one of a specification parameter, a status parameter, or an event parameter.

8. The system of claim 1, wherein the programmable circuitry is to cause a cloud automation platform to select parameter settings to update in the cloud resource configuration specification.

9. The system of claim 1, wherein the programmable circuitry is to cause transmission of the updated cloud resource configuration specification to a container orchestration platform server.

10. The system of claim 1, wherein a request for the cloud resource configuration state causes the programmable circuitry to convert cloud resource configuration information from the cloud provider to the cloud resource configuration state, the cloud resource configuration information in a cloud-provider-specific format, the cloud resource configuration state in a cloud-provider-agnostic format.

11. A non-transitory machine-readable medium comprising instruction to cause programmable circuitry to:
compare a cloud resource configuration state with a cloud resource target configuration;
update a cloud resource configuration specification based on a difference between the cloud resource configuration state and the cloud resource target configuration; and
cause an update of a cloud resource configuration parameter in a cloud provider based on an updated cloud resource configuration specification.

12. The non-transitory machine-readable medium of claim 11, wherein the instructions are to cause the programmable circuitry to request the cloud resource configuration state.

13. The non-transitory machine-readable medium of claim 11, wherein the instructions are to cause the programmable circuitry to compare the cloud resource configuration state to the cloud resource target configuration after polling for the cloud resource configuration state.

14. The non-transitory machine-readable medium of claim 11, wherein the instructions are to cause the programmable circuitry to compare the cloud resource configuration state to the cloud resource target configuration after detecting a trigger event from the cloud provider, the trigger event caused by a change in the cloud resource configuration state.

15. The non-transitory machine-readable medium of claim 14, wherein the instructions are to cause the programmable circuitry to respond to the trigger event by at least one of 1) creating the cloud resource configuration parameter, 2) updating the cloud resource configuration state, or 3) ignoring the trigger event if there is no difference between the cloud resource configuration state and the cloud resource target configuration.

16. The non-transitory machine-readable medium of claim 11, wherein the cloud resource configuration state includes current parameter settings.

17. The non-transitory machine-readable medium of claim 16, wherein the current parameter settings include at least one of a specification parameter, a status parameter, or an event parameter.

18. The non-transitory machine-readable medium of claim 11, wherein the instructions are to cause the programmable circuitry to cause a cloud automation platform to select parameter settings to update in the cloud resource configuration specification.

19. The non-transitory machine-readable medium of claim 11, wherein the instructions are to cause the programmable circuitry to cause a transmission of the cloud resource configuration specification to a container orchestration platform server.

20. The non-transitory machine-readable medium of claim 11, wherein after a request for the cloud resource configuration state, the instructions are to cause the programmable circuitry to convert cloud resource configuration information from the cloud provider to the cloud resource configuration state, the cloud resource configuration information in a cloud-provider-specific format, the cloud resource configuration state in a cloud-provider-agnostic format.

21. A method to manage a configuration of a cloud resource, the method comprising:
comparing a cloud resource configuration state with a cloud resource target configuration;
updating, with programmable circuitry, a cloud resource configuration specification based on a difference between the cloud resource configuration state and the cloud resource target configuration; and
causing an update of a cloud resource configuration parameter in a cloud provider.

22. The method of claim 21, further including requesting the cloud resource configuration state.

23. The method of claim 21, further including comparing the cloud resource configuration state to the cloud resource target configuration after polling for the cloud resource configuration state.

24. The method of claim 21, further including comparing the cloud resource configuration state to the cloud resource target configuration after detecting a trigger event from the cloud provider, the trigger event caused by a change in the cloud resource configuration state.

25. The method of claim 24, further including, after the trigger event, at least one of 1) creating the cloud resource configuration parameter, 2) updating the cloud resource configuration state, or 3) ignoring the trigger event if there is no difference between the cloud resource configuration state and the cloud resource target configuration.

26. The method of claim 21, wherein the cloud resource configuration state includes current parameter settings.

27. The method of claim 26, wherein the current parameter settings include at least one of a specification parameter, a status parameter, or an event parameter.

28. The method of claim 21, further including causing a cloud automation platform to select parameter settings to update in the cloud resource configuration specification.

29. The method of claim 21, further including transmitting an updated cloud resource configuration specification to a container orchestration platform server.

30. The method of claim 21, further including converting cloud resource configuration information from the cloud provider to the cloud resource configuration state, the cloud resource configuration information in a cloud-provider-specific format, the cloud resource configuration state in a cloud-provider-agnostic format.
